(19) United States
(12) Patent Application Publication
(10) Pub. No.: US 2026/0001367 A1
(43) Pub. Date: Jan. 1, 2026

(54) HIGH SPEED LASER PROCESSES FOR MARKING ARTICLES IN MOTION, AND MARKED ARTICLES

(71) Applicant: THE PROCTER & GAMBLE COMPANY, Cincinnati, OH (US)

(72) Inventors: Joseph Craig LESTER, Liberty Township, OH (US); Courtney Elizabeth BYRNE, Cincinnati, OH (US); Benjamin Jacob CLARE, Cincinnati, OH (US); Marc Andrew MAMAK, Mason, OH (US); Anthony M. OGG, West Chester, OH (US)

(21) Appl. No.: 19/248,577

(22) Filed: Jun. 25, 2025

Related U.S. Application Data
(60) Provisional application No. 63/664,365, filed on Jun. 26, 2024.

(51) Int. Cl. B41M 5/26

(52) U.S. Cl. CPC B41M 5/267

(57) ABSTRACT

An article of manufacture having a surface that is imprinted without ink, the imprinting having been effected via impartation of a pattern of substantially circular marks created by one or more of oxidation, reduction, ablation, etching, foaming, carbonization or annealing of material at and/or proximate the surface of the article.

### CROSS REFERENCE TO RELATED APPLICATION

This application claims the benefit of U.S. Provisional Application No. 63/664,365, filed Jun. 26, 2024, the substance of which is incorporated herein by reference.

### BACKGROUND

Short pulse duration laser marking utilizes energy from nano, pico and femto short-pulsed lasers across a variety of wavelengths and energies to mark surfaces to produce visible images, decorative patterns, text, bar codes, etc. onto articles such as products and/or packages. Any and all other marking techniques that may apply to the product and/or package (e.g., labels, screen print, digital print, etc.) can be used together with laser marking to achieve various decorative and functional effects. The laser technique used in short-pulsed laser marking is, importantly, a high through-put technique which uses a stationary laser source from which the laser beam is directed by means of electro-mechanically controlled mirrors (i.e., “galvo” sets) and lenses (e.g., f-theta and similar lenses) to the product or package being marked. These mirrors and lenses guide the target focus point of laser beam across a markable surface of the article (this guiding is sometimes called “scanning”) so that the laser can effect marks that collectively form an image on the surface. This approach has further advantages over other decoration techniques in that the use of a digital image (such as a PDF file) as a source of information for the laser controlling equipment allows for customization and personalization of the decoration.

There is interest in the possibilities presented by laser-marking articles such as by means of short-pulsed laser marking. For example, replacing adhesive labels on containers molded or otherwise formed of polymer resins may not only be economically beneficial, but ecologically beneficial as well. Eliminating adhesive labels on polymer containers, for example, decreases the total weight of the packaging material which reduces the amount of petroleum-derived material per package and reduces the weight of the packaging thereby requiring less fuel for shipping. Further, the absence of an adhesive label enables the polymeric container to be more easily recycled since adhesive labels often need to be removed prior to recycling due to the potential impurities which may be introduced to the recycle stream.

Laser marking of small articles (e.g., golf balls, etc.) and/or small regions on articles (e.g., date codes on finished packages, address labels) is known. While lasers are improving, and newer lasers have a variety of energies and wavelengths, these marking processes can still be slow and expensive. Further, they do not have the ability to mark small characters that require high-precision such as small-font text (e.g., usage instructions, ingredient listings) comprising alphanumeric characters. For example, date codes are marked onto packages by relatively quick laser marking systems, but they employ single lines of large, imprecisely, or unequally spaced spots (in the range of 250 μm to greater than 800 μm in diameter) and relatively large font characters. This is comparable to printing stick figures, which are adequate for some purposes but difficult for consumers to read and almost impossible for machines to read. More specifically, single lines of large, imprecisely, or unequally spaced spots cannot currently be used to mark high-precision small font text or machine-readable graphics such as UPC or QR codes on articles.

The current state of the art for laser marking processes includes “raster” marking processes and “vector” marking processes which are either fast but with poor precision and resolution, or slow but with higher precision and resolution. The combination of high speed, high precision and high resolution, while marking on articles that are in motion, appears to be absent in the prior art. This problem is particularly notable when marking large areas on articles, such as when using laser-marking as a full replacement for other decoration techniques, where all the text and/or graphics provided on at least one face of the article (much of which is required for regulatory purposes) is provided via laser-marking.

A raster laser marking process lays down individual laser marks in a grid, and the image is marked by the laser along successive parallel paths along a selected direction, point by point. Each of the pulses is “gated” such that a laser pulse is fired to create a single dot mark component or element of the desired character or image; and no pulse is fired as the laser beam target focus point sweeps over a spot where no mark component (i.e., an unmarked or blank space (“void”)) is desired. Each of the pulses is individually gated, and additionally, the pulse energy of each pulse can be varied to effect “grayscale” marks. Thus, the result may be compared to a print newspaper black-and-white reproduction of a photograph using a halftoning technique. State-of-the-art raster marking processes are effectively limited to lasers with a ˜100 kHz repetition rate given the practical limit of a ˜10 μs update rate in signaling the laser's on/off (i.e., “gating”), and the surface velocity can only be increased by increasing the pulse spacing, which can sacrifice fine detail that may be needed to effect legible/acceptable print quality of small-font text and graphics.

State of the art vector marking processes can be run above 100 kHz as the pulses are typically gated open while the laser beam target focus point and movement is guided (by mirrors) in the shape of the vector-lines being marked. Vector-marked articles comprising text can often be recognized as the marked lines are typically one-pulse wide (unless in-filled) and the pulses become closer together near the corners, where the surface velocity of the laser beam was slowed as it turned the corner. However, it has been found that the accuracy of the placement of the marks with vector-marking suffers, at high surface velocities of the laser beam path.

Currently, somewhat high-speed laser-marking can be achieved by polygon scanners (e.g., High Throughput Raster Processing Polygon scanner systems from Next Scan Technology, Evergem, Belgium), which can be optimized for high speed and accuracy. The polygon scanner systems employ a rotating polygon mirror for row scanning. These scanners are typically used for full-surface processing of a regular pattern. Specifically, the field of view is typically a square, which is relatively large by printing standards, and a repeated pattern is marked in its entirety over and over again on subsequent articles. The square field of view configuration of these scanners do not lend them to accurate marking to form images like small, detailed alphanumeric characters, logos, pictures and the like. Additionally, use of a polygon scanner presents an obstacle to reducing cycle time because the scanner scans the entire field of view regardless of whether marks are required at all locations within the field, for the subject print assignment.

Thus, there remains the need for faster, more economical, and more precise laser-marking. Both the hardware and the software that controls the lasing devices can be improved as well as the methods of using these improved lasing devices. Further, the method of disposition of the laser marks on the article can be improved to provide for both precision and speed.

Thus, it would be desirable to provide improved lasing devices together with software for operating the lasing devices and a process to mark articles with high-speed and high-precision (such as directly reproducing label information, aesthetic and functional features). These improvements should make the process fast, simple, cost-effective and scalable to mass manufacture and allow for the resulting articles to have consumer and machine-readable features that, among other benefits, can replace labels and adhesives. It would be further desirable to provide sufficient marking speed, precision and control that would enable marking articles on a production or packaging line while they are moving on a conveyor, to improve speed and economy of production and avoid a need for conveying machinery to be configured to pause movement of the articles for marking. Further, sufficient marking speed may in some circumstances enable a producer to avoid a need to divide the task of executing a print assignment on articles in motion into two or more portions, to be performed by two or more laser systems.

### BRIEF DESCRIPTION OF THE DRAWINGS

FIG. 1 depicts an example of an article imprinted with an alphanumeric character formed by a pattern of marks in a grid.

FIG. 2A is a two-dimensional schematic view of an example of a lasing marking system.

FIG. 2B is a two-dimensional schematic view of an example of positioning an article having a curving surface (shown in cross section) for marking, with respect to a focal plane.

FIG. 3 depicts an example of a grid wherein the locations in adjacent parallel rows are stacked.

FIG. 4 depicts an example of a grid wherein the locations in adjacent parallel rows are offset.

FIG. 5 schematically depicts an example of an alphanumeric character formed by marks in a grid.

FIG. 6A depicts an example of an alphanumeric character formed by marks in a grid.

FIG. 6B depicts an example of an alphanumeric character formed by marks effected via a prior art process.

FIG. 7 is an illustration of marks and voids effected as a result of packets of information sent to a laser controller according to the present disclosure.

FIG. 8 is an illustration of marks and voids effected as a result of packets of information sent to a laser controller according to the present disclosure.

FIG. 9 is an illustration of marks and voids effected as a result of packets of information sent to a laser controller according to the present disclosure.

FIG. 10 is an illustration of marks and voids effected as a result of packets of information sent to a laser controller according to the present disclosure.

FIGS. 11 and 12 depict examples of a portion of a grid wherein repeat distances are the same for rows and columns of locations within the grid, shown with marks imprinted at particular locations and voids in the remaining locations.

FIGS. 13 and 14 depict examples of a portion of a grid wherein repeat distances differ for rows and columns of locations within the grid, shown with marks imprinted at particular locations and voids in the remaining locations.

FIGS. 15 and 16 depict further examples of a portion of a grid wherein repeat distances differ for rows and columns of locations within the grid (in a differing respect from those shown in FIGS. 17 and 18), shown with marks imprinted at particular locations and voids in the remaining locations.

FIGS. 17 and 18 depict further examples of portions of grids wherein repeat distances differ for rows and columns of locations within the grid, shown in differing orientations.

FIGS. 19 and 20 depict further examples of portions of grids wherein repeat distances differ for rows and columns of locations within the grid, shown in differing orientations.

FIGS. 21 and 22 depict further examples of portions of grids wherein repeat distances differ for rows and columns of locations within the grid, shown in differing orientations.

FIG. 23 depicts an example of an arrangement of text, circumscribed by two possible grid outlines.

FIG. 24 depicts an example of an arrangement of text, circumscribed by a possible grid outline.

FIG. 25 depicts at close range a number of grid locations within a rectangular outline, with some of the locations reflecting marks and some reflecting voids.

FIG. 26 depicts at close range a number of grid locations within a conforming outline, with all of the locations reflecting marks.

FIG. 27 depicts a portion of a stacked grid reflecting markings at some locations.

FIGS. 28A-28D illustrate examples of imprinting an alphanumeric character via analog means (FIG. 28A) and via laser marking along grid patterns in varying arrangements (FIGS. 28B-28D).

FIGS. 29A-29D illustrate the examples shown in FIGS. 28A-28D, respectively, reduced in size to approximate 16 point.

FIG. 30 depicts a portion of an offset grid reflecting markings at some locations.

### DESCRIPTION OF EMBODIMENTS

### Article

“Article”, as used herein refers to an individual object such as an object for consumer usage, such as a container suitable for containing materials or compositions. The article may be a container, non-limiting examples of which include bottles, tubes, films, laminates, bags, wraps, drums, jars, cups, caps, and the like. The compositions contained in such containers may be any of a variety of compositions including, but not limited to detergents (e.g., laundry detergent, fabric softener, dish care, skin and hair care), beverages, powders, paper (e.g., tissues, wipes), diapers, beauty care compositions (e.g., cosmetics, lotions), medicinal, oral care (e.g., toothpaste, mouth wash), and the like. Containers may be used to store, transport, and/or dispense the materials and/or compositions contained therein. The article can be made of any a variety of common materials including; PET, PETG, HDPE, PP, PVOH, LDPE, LLDPE, steel, glass, aluminum, cellulose, pulp, paper, etc.

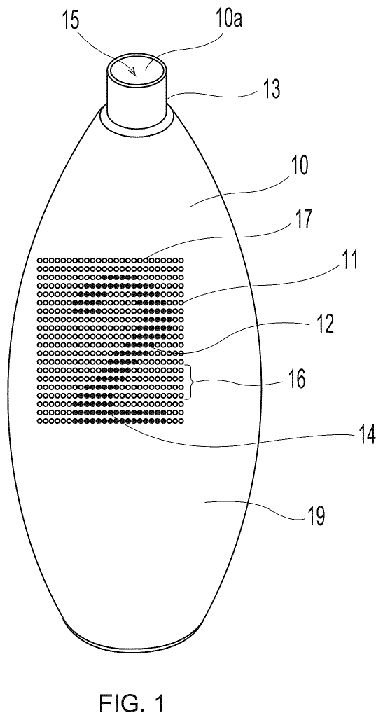

FIG. 1 schematically depicts an article 10 having an image 17 of an alphanumeric character formed by laser marks occupying locations within a grid 16. The image 17 can be consumer readable, machine readable or both. Image 17 can be, for example, an alphanumeric character, a company logo, a drawing, artwork, UPC or QR codes, and the like. In this instance, the marked locations 12 make up an alphanumeric character 14, which in this case is the number two, “2”. The unmarked locations 11 in the grid 16 are shown for illustration purposes only and do not appear on the final marked article 10. Article 10 is shown as a container and has an opening 10a and a neck 13 that provides access to the interior space 15.

An article according to the present disclosure may be formed of glass, a ceramic, a metal, a single thermoplastic polymer material, a non-thermoplastic polymer material, a cellulosic material, or from two or more materials that are different from each other in one or more aspects. The two or more materials may comprise layers within the article. Where the article has different layers, the materials making up each of the layers can be the same or different from any other layer. For example, the article may comprise one or more layers of a thermoplastic resin, selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), or a polyolefin, for example one of low-density polyethylene (LDPE), linear low-density polyethylene (LLPDE), high-density polyethylene (HDPE), propylene (PP) and any combinations thereof. The article may also comprise cellulosic materials such as pulp or paper. The cellulosic material may be included with an additional second material which may be a second cellulosic material or may comprise a resin including thermoplastic material or water/solvent borne coating. A glass, metal or ceramic forming an article (for example) may be coated with a coating material that reacts to energy delivered by a laser beam, in a manner that will impart a visible mark to the surface of the article.

Recycled thermoplastic and/or cellulosic materials may also be used, e.g., post-consumer recycled (“PCR”) materials, post-industrial recycled (“PIR”) materials and regrind materials, such as, for example polyethylene terephthalate (PCRPET), high density polyethylene (PCRHDPE), low density polyethylene (PCRLDPE), polyethylene terephthalate (PIRPET) high density polyethylene (PIRHDPE), low density polyethylene (PIRLDPE) and others.

The thermoplastic materials may include monomers derived from renewable resources and/or monomers derived from non-renewable (e.g., petroleum) resources or a combination thereof. For example, the thermoplastic resin may comprise polymers made from bio-derived monomers in whole, or comprise polymers partly made from bio-derived monomers and partly made from petroleum-derived monomers.

Pigments, colorants, and laser absorption additives may be added to the material of the articles contemplated herein. Suitable choice of the laser wavelength in combination with pigments/colorants/additives may provide for suitable marking of the article. In cases where increase in contrast or speed of marking is desired, inclusion of such pigments/colorants/additives may facilitate absorption of the laser energy, thereby serving as laser absorption additives. Laser absorption additives can facilitate forming the laser-marks and can make the laser-markings more vivid and more easily read by users and machines, as well as increase the rate at which the article can be marked. These laser absorption additives generally absorb the laser energy specific to the laser wavelength, followed by initiating a color change to the surrounding matrix (via local heating to cause carbonization, foaming, etc.) or the laser absorption additive itself undergoes a chemical or physical change. Titanium dioxide and carbon black are pigments commonly used to opacify containers in order to protect the contents from the effects of light and can also serve as laser absorption additives depending on the wavelength of the laser being used. Additional examples of laser absorption additives include: titanium dioxide (TiO₂), antimony tin oxide (ATO), ATO coated substrates such as mica, Sb₂O₃, indium tin oxide, tin oxides, iron oxides, zinc oxide, carbon black, graphitic carbon, bismuth oxide, mixed metal oxides, metal nitrides, doped metal nitrides, metal carbides, metal borides, tungsten oxides, doped tungsten oxides, metal phosphates (such as copper phosphate), pearlescent pigments, zero valent metals such as aluminum, and mixtures thereof. Examples of laser marking laser absorption additives are those commonly sold under the tradename “Iriotec®” by Merck KGaA of Darmstadt Germany.

### Pulsed Laser and Pulsed Laser System

A pulsed laser such as a short-pulsed laser may be used to mark the articles according to the present disclosure. Lasers for use in the present disclosure are commercially available and include lasers having nano-, pico-, and femto-second pulse duration. Short-pulsed lasers can emit pulses applied at relatively high energy-densities and high repetition rates, which are important to allow laser-marking at relatively high speed. For purposes herein, it may be desirable that the pulsed laser utilized be capable of pulsing at a repetition rate of at least 100 kHz, preferably at least 200 kHz, more preferably at least 500 kHz, and even more preferably at least 1000 kHz, or even 3,000 kHz. A strike of a laser beam pulse upon an article may effect a visible mark via oxidation, reduction, ablation, etching, foaming, carbonization or annealing of material at and/or proximate the surface of the article, at and/or proximate the location of the strike.

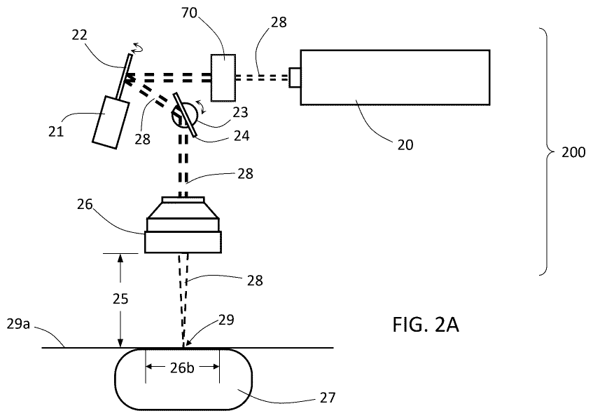

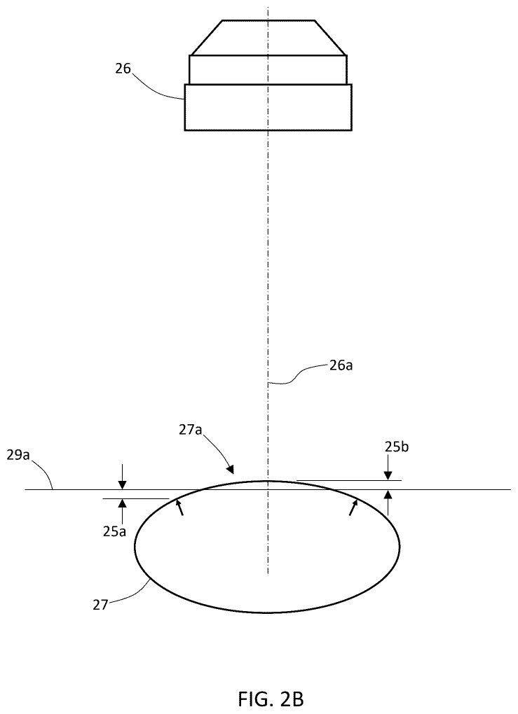

Any suitable pulsed laser can be used to mark an article 10. FIG. 2A schematically depicts an example of a pulsed laser system 200 comprising a pulsed laser 20 useful for marking an article surface. The pulsed laser system 200 includes a pulsed laser 20 which may be any laser capable of generating sufficient energy to mark the articles, such as, for example, a pulsed UV laser, having power in the range of 1 W to 200 W, and a laser light wavelength of 355 nanometers; or an IR pulsed marking laser, having an average power in the range of at least 100 W to 300 W, or to 500 W, 1000 W or even 2000 W, and a laser wavelength of 1030 or 1064 nanometers; or a pulsed green laser having a laser light wavelength of 515 or 532 nanometers and an average power range of 10 W to 1000 W.

For purposes of effecting rapid, clear, sharply-defined marking, it may be desired to utilize a laser of highest average power that is obtainable, recognizing that the power values of pulsed lasers available in the market are increasing with passage of time and advances in technology. Examples of suitable lasers are available from various suppliers, including an IPG ULPN-355-10-1-3-M marker or YLPN-1-1x350-50-3M MOPA module, available from IPG Photonics of Oxford, MA, United States. Other makes and types of lasers are also possible and different power ranges and settings may be used. The pulsed laser system can include optics that can be used to direct the laser beam, and/or to modify the laser beam such as by changing the energy density and/or spot size of the laser beam 28, as desired.

Frequency or Repetition Rate, measured in Hz, is the number of laser pulses a single laser can deliver in a second. For instance, a 1 MHz laser delivers 1,000,000 pulses per second where a 100 kHz repetition rate laser delivers 100,000 pulses per second. Repetition rate can be important for processing a laser-marked print assignment in a short amount of time (i.e., high-speed laser marking). Within the limits of the speed capability of the gating system, pulse frequency correlates (inversely) to the time required to mark a given row or column of a grid for a particular job almost linearly.

Pulse Energy is the amount of energy a single laser pulse contains and is typically measured in μJ or mJ. Typically, pulse energy is in the range of 5 μJ to 2000 μJ (2 mJ), preferably in the range of 7 μJ-1000 μJ, and more preferably 10 μJ-300 μJ. The average power of the laser, then, is given as the pulse energy times the repetition rate:

Average power=pulse energy(J)*rep rate(Hz or 1/sec).

Peak power is equal to pulse energy divided by pulse duration, and pulse duration can be less than 100 nanoseconds, less than 50 nanoseconds, less than 20 nanoseconds, less than 10 nanoseconds, less than 1 nanosecond, less than 500 picoseconds, less than 100 picoseconds, less than 20 picoseconds, less than 800 femtoseconds, less than 500 femtoseconds, less than 200 femtoseconds. Therefore, pulse energy and pulse duration are linearly related to peak power. The relatively shorter pulse durations achievable with nanosecond, picosecond and femtosecond lasers provide for relatively higher peak power which can improve marking effectiveness and sharpness of the effected marks.

In the pulsed laser system 200 schematically depicted in FIG. 2A, the laser 20 emits laser beam 28, which is directed to a beam guidance system which may include an X-Y galvo set. The X-Y galvo set may include X-mirror 22 which is rotated by X-galvo 21 and Y-mirror 24 which is rotated by Y-galvo 23. Where the beam guidance system includes an X-Y galvo set, laser beam 28 is directed to X-mirror 22, is then reflected and redirected by X-mirror 22 to Y-mirror 24. Y-mirror 24 then reflects and redirects beam 28 to lens(es) 26. The X and Y mirrors 22 and 24 are respectively rotated by X- and Y-galvos 21 and 23, which are operated, respectively, to work together to direct the target focus point of laser beam 28 to a location at or proximate to where a desired mark is to be effected on article 27 with a markable surface. If as in some examples the markable surface is planar, it is preferably positioned for marking along or proximate a focal plane 29a. Before laser beam 28 reaches focal plane 29a and article 27, it will pass through one or more focusing lens(es) 26, which focus the beam. The distance from the forwardmost physical edge of the focusing lens 26 to the focal plane 29a is the working distance 25. The focal plane 29a is normal to the optical axis of the focusing lens. The working distance 25 is the distance from the forwardmost physical edge of the lens at which the lens most tightly focuses the beam 28, at target focus point 29, which lies in the focal plane 29a. (Note: The working distance may be close to, but may differ, from the focal length of the lens. The focal length of the lens is a function of the particular lens design, and is typically specified by the lens manufacturer.) In some examples, it may be desired that the lens be a flat-field lens which can provide tight focus of the beam along an extended area (field of view 26b) of a focal plane (i.e., in regions of the focal plane spaced away from the optical axis). In some examples, it may be desired that the lens be an f-theta lens, which provides the function of a flat-field lens, and in addition, causes distance of the laser focus point sweep along the focal plane to have a linear relationship with change of incident angle of the beam striking the lens (known in the art as θ (theta)—the angle between the incident beam direction and the optical axis). Both a flat-field lens and an f-theta lens can facilitate improvement of marking effectiveness over an extended area of a markable surface of an article, by providing tight focus of the beam at regions of the focal plane, within a field of view 26b of the lens, that are distanced from the intersection of the optical axis and the focal plane. The X-Y galvo set is configured to operate to sweep the laser beam within the field of view 26b of the lens along the focal plane 29a.

The combined optics of the pulsed laser system (including the beam guidance system and the lens(es)) may be controlled to sweep the laser beam target focus point across the markable surface of an article along predetermined/programmed paths.

For marking on a desired print area of markable surface that is substantially planar, it may be desirable to position the article such that the desired print area lies substantially within the focal plane, including examples in which the article is being translated on a conveyor. For marking on a desired print area of a markable surface that has contour/curvature, it may be desirable to position the article such that, when the desired print area is approximately or substantially centered about the optical axis, the average distance between the desired print area and the focal plane is as small as possible. This will ensure tightest possible focus of the beam (smallest spot size) on average, on the desired print area. A simpler but still effective approach for ensuring effectively tight focus/small spot size, however, may be to simply position the article for printing such that, when the desired print area is substantially centered about the optical axis, the respective locations of the desired print area of the surface that are, respectively, nearest, and farthest, from the lens, are substantially equidistant from the focal plane (and on either side of it). This latter simpler approach is schematically illustrated in two dimensions in FIG. 2B. In the illustrated example, the article 27 is shown in horizontal cross section. The desired print area 27a on a curving surface of article 27 is bounded at the two smaller arrows in the figure. The article 27 is shown positioned for marking, such that, when the print area 27a is approximately or substantially centered about optical axis 26a of lens 26, distance 25a is approximately or substantially equal to distance 25b. Distance 25a is the distance between the focal plane 29a and the location of the print area 27a that is farthest from the lens 26. Distance 25b is the distance between the focal plane 29a and the location of the print area 27a that is closest to the lens 26. It has been learned that, as focal length is increased to the greater distances contemplated herein, sensitivity of the process to relatively minor deviations of distance of points on a desired print area, from the focal plane, are reduced—in other words, acceptable marking effectiveness is more easily maintained along curving print area surfaces, at greater focal lengths. In any event contemplated herein, however, marks imparted to a curved or contoured surface will vary in size slightly according to distance from the focal plane of portions of the curving surface during marking. At locations on the surface that are in or nearest the focal plane during marking, the laser beam pulses are focused most tightly and the spot sizes will be at their smallest; at locations further removed from the focal plane during marking, the laser beam pulses are less tightly focused and the spot sizes will be relatively larger.

The laser beam target focus point may be caused to sweep across the focal plane, along a first path in a grid in a sweep direction, while emitting (and/or omitting/withholding) beam pulses. The combination of the constant sweep-speed of the laser beam target focus point across the focal plane of the article, also called the constant surface velocity of the laser beam, and the repetition rate of the laser pulses, then, determines the repeat distance of marks along the sweep direction along the focal plane.

Repeat distance×Repetition Rate=Surface Velocity

The pulsed laser system includes a gating system, such that the pulsed laser system may emit beam pulses or series of pulses at the pulse repetition rate of the laser, and alternatively, omit or withhold pulses or series of pulses at the pulse repetition rate of the laser, while the associated guidance system (e.g., X-Y galvo set and suitable lens(es)) causes the beam target focus point to sweep along a selected sweep path across the focal plane at a given location along a grid, thereby imparting marks on the article corresponding to the path, or alternatively, leaving unmarked location(s) (herein, “void(s)” along the path. The laser beam target focus point may be swept across the focal plane at a constant surface velocity relative the focal plane while the pulsed laser system is emitting and/or omitting/withholding pulses. The surface velocity (sweep speed) is defined above. The beam target focus point may subsequently be controlled to sweep across the focal plane along a second path within the grid, adjacent and parallel to the first path, while emitting (and/or omitting) pulses. The laser beam target focus point may controlled to sweep across the first, second and subsequent paths along the focal plane in the same direction or in alternating directions. For example, the laser beam target focus point may be controlled to sweep across the first path from “left-to-right” and across the subsequent/adjacent path from “right-to-left,” or “up-to-down,” or “down-to-up”, or otherwise, in any other opposite directions of travel.

The energy conveyed by the laser beam must be absorbed by the material at or proximate the surface of the article in the desired print area to enable marking. The laser energy may be absorbed by the base material and/or a laser absorption additive to the base material constituting the print area surface, by a coating material, or by an energy-absorbing layer proximate but subjacent the surface. The laser may be chosen according to the wavelength of the beam it generates, to coincide with an absorption band, band gap energy, or surface plasmon/plasma resonance frequency in the UV-vis-NIR-IR spectrum of at least one of the article's base material or a laser absorption additive incorporated into the article. For example, pulsed lasers utilizing 355 nm (UV) may be absorbed by TiO₂ added to the article, 532 nm (Green) may be absorbed by precious metal nanoparticles like gold, silver and copper. Other laser wavelengths such as 1030 nm-1064 nm or 9-12 μm (Infrared) may be absorbed by PET which may be the base material of the article. Other pairings of laser wavelengths with base materials or laser absorption additives for the article exist and are contemplated herein.

### Laser Marking

Marking may be accomplished by one or more processes including but not necessarily limited to any of foaming, carbonization, ablation, etching, reduction, oxidation, annealing, curing, melting and/or phase change of material at or proximate the markable surface of the article, such that a visible change of coloration is effected and the mark location.

Foaming is a process whereby the laser beam energy melts and vaporizes a portion of polymer resin material, which creates gas bubbles that become trapped within the molten resin and reflect light diffusely (effecting opacification) upon cooling. Foaming will generally produce lighter and/or opacifying markings in the areas marked, and this method is most commonly used for materials such as, for example, thermoplastic polymers, that are capable of melting and vaporizing, and are relatively medium-toned to dark in color and either opaque or translucent. “Translucent” as used herein means the material, layer, article, or portion of the article being measured has total luminous transmittance of greater than 0% and less than or equal to 90%. “Opaque” as used herein means the material, layer, article, or portion of the article being measured has total luminous transmittance of about 0%. The total luminous transmittance is measured in accordance with ASTM D1003.

Carbonization is a process that produces dark contrasts on bright surfaces, and is commonly used on carbon-containing polymers or bio-polymers or natural materials such as such as leather, wood, cellulosic and cellulosic fiber- or pulp-based materials. When carbonizing a material, the laser beam energy heats the surface of the material (generally to a minimum 100° C.) causing emission of oxygen, hydrogen, or a combination of decomposition products. Carbonizing generally effects dark marks with higher carbon content than the unmarked material, making it candidate process for lighter-colored surfaces.

Reduction or oxidation occur when the laser beam energy changes the oxidation state of at least one of the article's components such as a laser absorption additive or opacifying pigment, resulting in a discoloration or color change that is visible as a mark. For example, without intending to be bound by theory, it is believed that the energy delivered by a UV laser beam can promote the reduction of TiO₂ to form a titanium sub-oxide where the oxidation state of titanium has been reduced to less than +4 and whereby this reduction results in a color change from white/colorless to blue, dark blue to black.

There are additional methods of marking an article. For example, annealing is a unique laser process available for metals and other materials. The energy from the laser beam creates an oxidation process at or near the surface of the material, which results in a change of color on the material surface.

Staining is another marking process achievable as the result of the chemical reaction created on materials when the energy of a laser beam is applied. Variations in color shades will depend on the compositions of the materials being stained. For example, lighter colored plastic materials can often discolor during the laser etching process, resulting in dark marking from the soot particles produced.

Laser engraving is another process that includes removing material as the workpiece surface is melted and evaporated by the laser beam, which produces an impression in the surface being engraved. Removing material is also sometimes referred to as etching or ablating. Laser etching is a process where the laser beam removes the top-most surface of a substrate or coating that was previously applied to the article's substrate. A contrast is produced as a result of the different colors of topcoat and substrate or different topography and texture of the etched region versus the adjacent region. Common materials that are laser marked by way of removing of material include anodized aluminum, coated metals, foils and films, or laminates. The term “etch” as used herein as a noun, refers to the cavity formed when material is removed from a surface. As a verb, the terms “etch” and “etching” refers to the act of removing material from a surface. Etching can be performed mechanically, chemically and thermally (e.g., via laser). Although there is no specific limitation on the maximum or minimum depth of an etch, etching depths are typically in the range of about 0.01 mm to about 2.0 mm, including any depth within the range, such as for example, 0.010 mm, 0.075 mm, 0.100 mm, 0.200 mm, 0.300 mm, 0.400 mm, 0.500 mm, 1.0 mm, 1.5 mm and more, from the unetched surface. The edges of an etched cavity may be marked by elevated boundaries formed of foamed and/or melted/displaced/re-cooled material.

Bleaching or photobleaching (sometimes termed fading) is the photochemical alteration of a chromophore (such as in a pigment or dye) or fluorophore molecule such that its inherent color is permanently lost and/or is unable to fluoresce. This is caused by cleaving of covalent bonds or non-specific reactions between the chromophore/fluorophore and surrounding molecules and can also be affected with laser-marking.

Spot (individual mark) size is an important parameter of laser marking as contemplated herein, and relates to the focused area where the laser beam strikes the markable surface. “Spot size” is the diameter of a substantially round mark. Substantially circular/round spots effected by a beam strike zone on the article may be deemed desirable in most applications for purposes of most effective and rapid marking, sharp contrast, control and precision, but it is possible to effect elliptical spot shapes by control of the laser beam optics relative to the article. Spot size can be modified by focusing or de-focusing the laser beam, but the “fluence” (=energy delivered per unit markable area) within the spot decreases as the spot is enlarged or de-focused. Theoretically, the minimum spot-size achievable with any laser is the wavelength of the laser beam itself. As a practical matter, the minimum spot size achievable with pulsed lasers is ˜7-20 μm. Spot size of the laser markings as contemplated herein may be in the range of from about 10 μm to about 300 μm, preferably from about 20 μm to about 250 μm, more preferably from about 30 μm to about 100 μm, and even more preferably from about 40 μm to about 60 μm. Spot sizes for conventional laser markings for date codes (for example using CO₂ lasers) and the like are typically at a minimum of 250 μm and can exceed 800 μm. If relatively fine detail and/or high resolution are desired, relatively smaller spot sizes are preferable. Conversely, if fine detail and/or high resolution are not a priority, larger spot sizes may be acceptable. However, laser marking typically requires a minimum fluence to effect the desired marks, so balancing pulse energy, pulse duration, pulse overlap and spot size may be important.

Further, there is a region around the laser beam contact spot that may also be heated in the course of the marking, though little or no material would be marked. This “heat-affected zone” can still yield effects such as crystallization, which can impact the appearance and/or performance of the material. Short-pulsed lasers (e.g., nano-second lasers) can impart some heat-affected zone, although substantially less than micro-second pulse or CW type lasers (e.g., CO₂, longer pulse IR lasers, etc.). Pico- and femto-second lasers are often termed “ultra-short pulse” and impart very little to no heat-affected zone. This capability is helpful to control the thermal effects of the marking.

Geometry of the mark spacing is a contributor to the cycle time and fluence (or energy per unit area) delivered to an article markable surface. For example, the spacing between marks may be such that the marks do not overlap at all, i.e., have 0% overlap. At 0% overlap, each individual laser pulse is the sole source of the energy delivered to effect each discrete mark. If the laser does not have sufficient pulse energy or peak power to effect a desired mark on the markable surface, then one can decrease the pulse spacing (by adjusting the spacing of locations in the grid) to the point where the spots overlap in either one or both grid column and row directions. Overlapping the spots involves delivering more than one laser beam pulse to an overlap area of the markable surface such that sequential beam pulses each strike the overlap area, delivering higher fluence or energy per unit area in the overlap area.

Pulse spacing is a controllable variable that affects cycle time. If a laser has a fixed repetition rate or pulse frequency, then to achieve the lowest process time (also called cycle time) one would want to spread the pulses out (by increasing either or both the spacing of rows and columns of the grid) as much as possible, while retaining the desired levels of image legibility, appearance quality and/or resolution. In some examples contemplated herein, the pulses and resulting effected marks are non-overlapping.

Pulse duration is the length of time a pulse remains continuously above half its maximum value (peak power). The shorter the pulse duration, the greater is the peak power that can be achieved, under constant average power. This is because average power=pulse energy (J)*rep rate (Hz or 1/sec). Peak power is equal to pulse energy divided by pulse duration. Therefore, when pulse duration is reduced, peak power is increased. Increasing peak power enables faster and/or improved carbonization, foaming, oxidation, reduction, etc. at the markable surface, while reducing pulse duration deceases or eliminates the extent of heat-affected zones outside the direct focus of the beam.

The power output of the laser (and resulting fluence) can be manipulated during marking, such that power varies pulse-to-pulse, to impart a grayscale effect, also known as dithering. Such a process is a known aspect of the raster-process of laser-marking. Without intending to be bound by theory, however, it is believed that such dithering during laser-marking also increases process time, because the pulsed laser system must receive a separate and added signal component for each pulse, to control power level. In examples contemplated herein, the laser pulses are emitted at constant power. Constant power may be maintained while the laser is marking within an entire row or even as the laser marks among rows over the course of the entire marked pattern.

### Grid

As used herein, “grid” or “bitmap grid” means a regularly-spaced, periodic array of discrete locations along a focal plane, at which laser marks on a proximate markable surface of an article may be effected, or not, to collectively form a desired visible image, alphanumeric characters/text, bar code, QR code, etc. on the print area. The periodicity of the array includes periodicity in of respective columns and rows of locations in the grid. Following laser marking of a surface, each location of the print surface proximate the corresponding location along the focal plane may bear a laser-effected mark, or be left unmarked, i.e., as a “void”. As discussed herein, the pulsed laser system sweeps the target focus point for the laser beam across the focal plane, while the laser beam pulses are either emitted or omitted/withheld. A mark is effected on the markable surface when the laser emits a pulse that strikes the surface at a location corresponding with a grid location on the focal plane, and an unmarked location (void) remains as such when the laser does not emit a pulse that strikes the article surface at a location, as the beam target focus point sweeps over it. The laser beam target focus point may be swept across the focal plane at a constant surface velocity while the repetition rate of the laser is constant, so the periodicity of locations along the focal plane will be regular in the direction along which the laser beam is swept, even though the spacing of marked locations may not be equal, given the possibility of unmarked locations/voids. In the event of unmarked locations/voids, the distance between centers of any marked locations along the same direction (i.e., in the target focus point sweep direction) will be an integer (e.g., 2×, 3× or larger) of the smallest distance measured between centers of marks in that direction.

The laser beam target focus point may be swept across the focal plane through the grid, in subsequent, successive, parallel paths along series of locations in the grid. The laser beam target focus point may be swept in the same direction as it is moved from sweep path to adjacent sweep path of the grid (e.g., like the carriage-return on a typewriter, as in a raster process) or may be swept in alternatingly opposition directions as it moves from sweep path to sweep path. A contributor to reducing cycle time includes sweeping the laser beam target focus point in alternating directions as it moves from sweep path to adjacent sweep path. The rows and columns of the grid, respectively, may be generally parallel to one another. The locations in adjacent rows may lie directly above/below one another or may be offset relative to one another, and the locations in adjacent columns may lie directly side-by-side each other or may be offset relative to one another. An offset results in a realignment of the locations between rows.

An alphanumeric character is a letter, other symbol used in written language, or a number. For example, in English (which uses the Latin alphabet and script) uses letters are A through Z including upper case and lower case; and numbers are expressed using Arabic numerals 0 to 9. Herein, the term “alphanumeric character” is not limited to any particular language, alphabet, script, style or font. By way of non-limiting example, English; Chinese; Spanish; Portuguese; Italian; Greek; French; German; Japanese; Russian; Arabic; Hindi and other languages; and Latin, Greek and Cyrillic scripts; Chinese logograms; Japanese Katakana; Arabic script; Devanagari script and other alphabets/scripts have different alphanumeric characters that can be printed via use of a pulsed laser system contemplated herein.

The size of a printed, or in the present case marked, alphanumeric character is a feature of its font, with size expressed as “point”, or as abbreviated, “pt”. For alphabetic characters of at least, for example, the Cyrillic, Greek and Latin scripts, among others, the smallest font generally accepted to be readable by consumers, on an imprinted article, is 6 point. Fonts can be increased to very large sizes, but when imprinting a designated print area of a consumer package, for example, larger fonts, e.g., in excess of 20 point, may be deemed impractical because they may be too large to enable imprinting of a desired amount of information within a designated print area.

As previously discussed, the laser-effected marks may be arranged to be non-overlapping, to reduce the number of marks required, and thereby reduce the time required to mark, along a given grid (i.e., cycle time). Cycle time can be further reduced by spacing out the grid locations along either or both of the column spacings or row spacings, however, overly increasing spacing can result poor legibility and/or poor appearance quality of alphanumeric characters or images constituting the desired printing. Nevertheless, increasing the repeat distance allows for a greater surface velocity of the laser beam sweep across the surface of the article when marking along a sweep path (at a constant pulse repetition rate); and selecting the most efficient sweep direction reduces the number of turnarounds required to mark in a given grid. A balance between most permissible efficiency (i.e., smallest permissible cycle time) and a satisfactory level of legibility/appearance quality/resolution may be struck. Repeat distance may be increased by increasing one or both of column spacing and row spacing of locations in the grid.

For a pattern of marks/voids according to a grid pattern, minimizing the number of turnarounds required may in some circumstances have a greater impact on reducing time to mark than increasing the repeat distance (faster surface velocity). While conventional raster marking processes include equal column and row spacings, the present disclosure contemplates use of a grid having differing column and row spacings. It has further been found that legibility of alphanumeric characters marked by the constant surface velocity (CV) bitmap process contemplated herein can depend on the grid location spacing as a function of the font size of the character(s). The column spacing for typical print assignments that include text constituted by alphanumeric characters is preferably in the range of from about 0.005 mm to about 0.500 mm; more preferably from about 0.010 mm to about 0.200 mm; and even more preferably from about 0.040 mm to about 0.100 mm. The row spacing is preferably in the range of from about 0.010 mm to about 2.0 mm; more preferably from about 0.050 mm to about 0.150 mm; and even more preferably from about 0.060 mm to about 0.075 mm.

When alphanumeric characters desired to be imprinted have a font size within the range of 6 pt to 10 pt, the row spacing may be at least 1.2, preferably 1.5, more preferably 1.7, and even more preferably 2 times the column spacing. When alphanumeric characters desired to be imprinted have a font size within the range of 11 pt to 16 pt, the row spacing may be at least 2, preferably 2.5, more preferably 3, and even more preferably 4 times the row spacing.

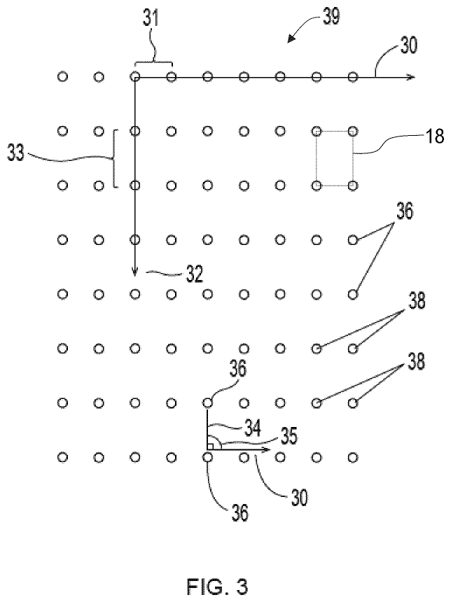

FIGS. 3, 4, and 5 depict various examples of portions of grids as contemplated herein. More specifically, FIG. 3 is an example of a portion of a grid 39, illustrating a possible row direction 30, column direction 32, column spacing 31 and row spacing 33. Potential marking locations 36 are depicted by the empty circles making up the grid. Further, in FIG. 3 the locations 36 among parallel rows 38 are “stacked” when the angle 35 between locations in adjacent row 34 drawn in the column direction between two potential marking locations and the row direction 30 is approximately 90 degrees. In other words, if one uses vectors to connect neighboring marks from the array to form a parallelogram (e.g., unit cell 18), when the interior angles of the parallelogram are approximately 90 degrees, the locations are stacked. When the interior angles of the parallelograms differ from 90 degree (e.g., 120 and 60 degrees), the locations are offset. The column spacing is measured from the center of one location to the center of an adjacent location in the row direction.

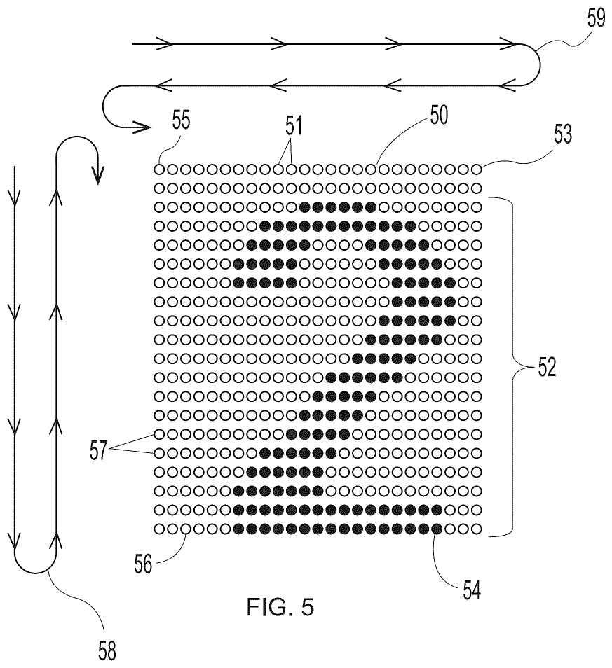

The unit cell of a grid has four symmetrical axes: horizontal, vertical, and two diagonal. The laser marking discussed herein (i.e., the target focus point sweep path) can occur along any of those four axes. The vertical and horizontal directions shown in FIG. 5 are described for simplicity. FIG. 5 could be rotated 45 degrees and then the diagonals become vertical and horizontal. Again, the laser marking occurs during sweep of the target focus point along a sweep path, then the focus point shift is shifted to an adjacent sweep path, and laser marking occurs during sweep of the target focus point in the opposite direction, an example of which is illustrated in FIG. 5.

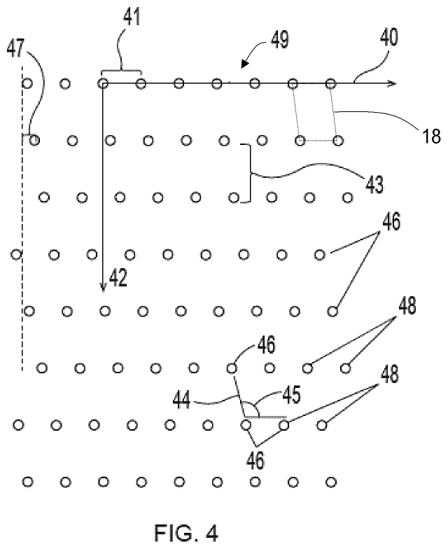

FIG. 4 depicts another example of grid 49 as contemplated herein, showing an offset 44, having an offset distance 47 between adjacent parallel rows 48. Offset 44 is defined by angle 45 between locations 46 in one row 48 and the nearest location 46 in an adjacent row 48, wherein an offset 44 exists when angle 45 is greater than or less than 90 degrees. FIG. 4 further depicts examples of a row direction 40, column spacing 41, column direction 42, and row spacing 43.

FIG. 5 depicts an example of an alphanumeric character 52 formed of marks in a grid 50. The alphanumeric character is the numeral “2” and is constituted by laser marks at locations 54, which are in contrast to unmarked locations (voids) 56. When multiple alphanumeric characters are imprinted, for example, a word, a sentence or a paragraph, the characters sharing the same line of text may also share the same horizontal rows 53 of laser markings. If, for example, the laser beam target focus point is swept horizontally, the laser apparatus will guide the beam to sweep across one row, with beam pulses effecting marks at locations 54 as needed to form individual alphanumeric characters with the desired level of resolution, and leave the necessary number of unmarked locations 56 between characters, to form a row with markings effective to constitute a plurality of characters for that row. By this method, marks to form characters, words, sentences, and paragraphs can be effected with sufficient numerical densities along the horizontal and vertical directions, to achieve the desired level of legibility and quality of appearance.

With respect to FIG. 5, horizontal rows 53 and vertical columns 55 define grid 50.

If the beam target focus point sweeps the grid in the horizontal direction 59, the distance 51 between centers of marked or unmarked locations (54 or 56) in horizontal rows 53 defines the repeat distance, and the distance 57 between centers of marked and unmarked locations in vertical columns 55 defines the distance between sweep paths.

Conversely, if the beam target focus point is to sweep the grid in the vertical direction 58, the distance 57 between centers of marked or unmarked locations (54 or 56) in vertical columns 53 defines the repeat distance, and the distance 51 between centers of marked and unmarked locations in horizontal rows 53 defines the distance between sweep paths.

In the example illustrated, the marked locations 54 may be marked in the horizontal direction 59 (via horizontal sweep of the beam target focus point, row-by-row), or the vertical direction 58 (via vertical sweep of the beam target focus point, column-by-column). More specifically, when marking in the horizontal direction 59, the laser beam target focus point sweeps across a horizontal row 53 either marking, or leaving an unmarked void, at each location (54 and 56, respectively). Then, the laser beam target focus point moves down or up to the next sweep path and begins sweeping across another row above or below the row previously marked. Conversely, when marking in the vertical direction 58 the laser beam target focus point sweeps up or down a vertical column 55 either marking, or leaving an unmarked void, at each location (54 and 56, respectively). Then the laser moves across to the next sweep path and begins traveling up or down a vertical column adjacent the vertical column previously marked.

The aspect ratio of an alphanumeric character is the ratio of its height to its width, as viewed in normal reading orientation. The aspect ratio of the imprinted number “2” shown in FIG. 5 is greater than 1 because its height is greater than its width. In the example shown in FIG. 5, one can see that sweeping the beam to effect marks to imprint the number “2” as shown, in the vertical direction 58, would require fewer turnarounds than marking in the horizontal direction 59. Thus, marking this character, alone, may be faster when sweeping the laser-beam while marking in the vertical direction 58. However, other factors can be relevant to a decision whether to mark in a horizontal or vertical direction. For example, if the numeral “2” as shown in FIG. 5 is only one character in a sentence or paragraph of text to be imprinted in a larger grid and/or a grid for imprinting a graphic image, the most efficient sweep direction could be different.

A grid 39 may be a stacked grid, as depicted in FIG. 3. In a stacked grid, the locations where the marks may be applied in a first row are directly above the locations in a second row immediately above or below the first row. Said another way, the angle 35 formed between the row-segment connecting a first location along the first row with an adjacent location along the first row and the row-segment connecting the first location with its nearest location along the second row is 90°.

A grid may be an offset grid as depicted in FIG. 4. In the example of an offset grid 49 as shown in FIG. 4, the locations where the marks may be applied in a first row are not directly above the locations in a second row immediately below the first row. Said another way, the angle 45 formed between a first line segment connecting a first location along a first row with an adjacent location along the first row, and a line segment connecting the first location with its nearest location along the second row is greater than or less than 90°.

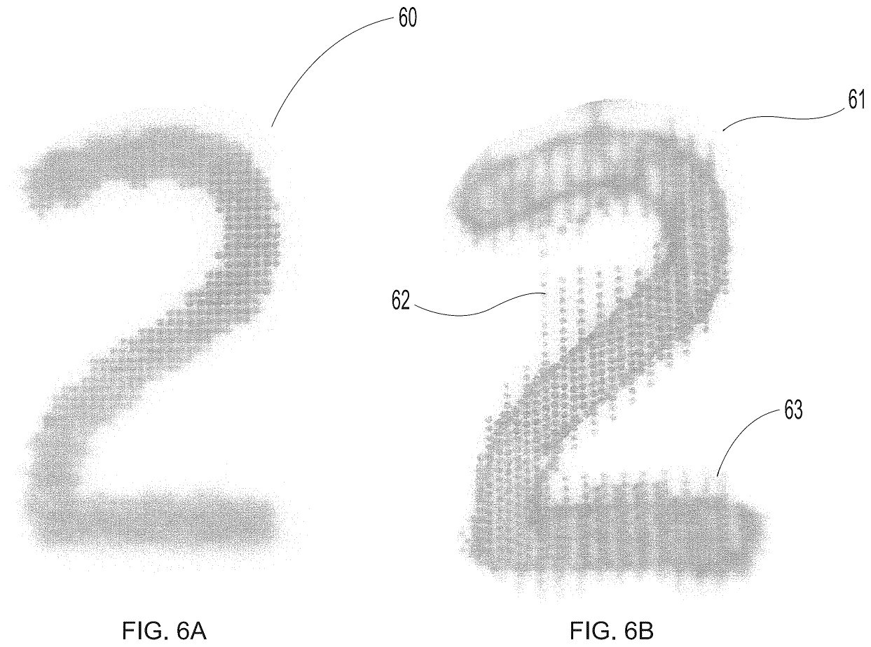

The sweep path direction is chosen relative to the arrangement of locations in a predetermined grid, which is laid out to effect the desired imprinting with desired legibility and appearance quality/resolution. For example, FIG. 6B depicts an example of a “2” made by laser marking wherein the sweep direction is vertical with respect to the marked “2” 61 as ordinarily read/viewed. Depending upon other choices made in laying out the print subject matter and the grid, however, the sweep direction could be horizontal with respect to the marked “2” 61, or diagonal. For an ordinary arrangement (i.e., not stylistically altered in a manner atypical of normal text reading configuration) of alphanumeric text along horizontal rows or columns according to its normal reading orientation, the greater of the row and column spacings may in some examples correspond with an average aspect ratio of the alphanumeric characters. If the average aspect ratio of the alphanumeric characters (average ratio of height to width) is greater than 1, then the greater of the row and column spacings may lie along the vertical direction in many examples, according to the orientation of the alphanumeric characters as they are ordinarily read.

The locations on the grid may be regularly-spaced along respective horizontal and vertical directions, or may be regularly-spaced along directions oblique to the horizontal and vertical directions. In examples where the markable surface of the article 27 to be imprinted is planar and as positioned for laser-marking is proximate to or substantially coincides with the focal plane 29a of the lens 26 (e.g., see FIG. 2A), the marks imparted to the markable surface will substantially coincide with the corresponding grid locations. In examples where the article surface to be printed is contoured/curved (not planar), it may be desired to position the article during marking as described above (and, e.g., see FIG. 2B). (With respect to positioning a planar markable surface “proximate to” a focal plane, “proximate to” means closely enough to the focal plane to provide for effective marking, even though tightest focus of the beam occurs at the focal plane.)

A grid may have differing regions, such that column and row spacings differ between them. Differing regions with differing, discrete print assignments may accommodate or require differing levels of resolution. For example, a first column spacing may be used consistently when marking alphanumeric characters and a second, differing column spacing may be used when marking machine-readable codes such as UPC or QR codes. Similarly, the row spacing may remain the same, or may differ among regions within the grid. The surface (sweep) velocity of the laser beam target focus point and/or the sweep direction (i.e., up/down, side-to-side or diagonal) may also differ among differing regions. The laser marking process contemplated herein, however is typically done at constant speed when the laser beam target focus point is executing a marking sweep. Following the time it reaches the end of one sweep path, the laser beam target focus point is guided by the X-Y galvo set to decelerate from its constant sweep velocity, shift to the next sweep path to be processed, reverse direction, and then accelerate back to the constant velocity to begin processing the next sweep path. The sweep speed (surface velocity) during processing of a sweep path may be consistent throughout the marking of the entire grid, or regions thereof, or may change from region to region. Articles marked with the CV-bitmap grid marking process contemplated herein can be distinguished from articles marked with a vector marking process, by, among other features, the regular periodicity of marks and often by the absence of outlines or “borders” that define the marked area; see for example FIG. 6B, border 63.

FIGS. 6A and 6B illustrate the difference between laser marking via bitmap grid marking with the CV-bitmap process contemplated herein reflected in FIG. 6A, and the prior vector marking process reflected in FIG. 6B. In both cases an alphanumeric character 60 and 61 (i.e., the number “2”) has been formed by marks effected by a pulsed laser. The alphanumeric character 60 (FIG. 6A) is substantially better-defined with cleaner edges, and fewer stray markings. FIG. 6B stands in contrast, with poorly-defined edges and a number of stray markings 62 outside the desired visually-perceivable outline of alphanumeric character 61. The marks of the examples shown in FIGS. 6A and 6B were effected in approximately the same amount of time for each.

The arrangement of any given grid shape and size to be utilized, and the directional orientation and spacing of its rows and columns, to effect imprinting via laser marking on a markable surface of an article, will be affected by the subject article's physical size and shape; the dimensions, shape and surface area of the print area desired; the quantity of alphanumeric text characters and/or graphic content to be imprinted in the print area or region(s) thereof, font choices, judgments concerning desired legibility and appearance quality/resolution; and the layout(s) thereof. The grid will encompass the desired print area.

Configuring a Grid for Printing Alphanumeric Characters with Reduced Cycle Time

The quantity of alphanumeric characters required to be imprinted within the print area, together with stylistic choices, and desired legibility and quality of appearance, will affect choice of print font style and size, character spacing and line spacing. Additionally, where graphic image(s) are to be imprinted, the level of resolution desired for the image(s) desired must be determined and specified.

Working within these conditions, it has been discovered that one may maximize marking/imprinting speed (conversely, minimize required marking/imprinting time, i.e., cycle time) by minimizing each of two variables.

First, one should minimize the total number of potential mark/void locations along rows and columns that must be included in the grid, to produce the print and/or image content desired, with acceptable legibility and appearance quality/resolution.

Second, one should choose the sweep direction as the one that will (1) require the smaller number of turnarounds; and/or (2) require the highest number of emitted pulses (effecting marks) per sweep.

In examples in which alphanumeric text is to be imprinted, the first step may be accomplished by identifying a first direction along which the lowest numeric density of marks (i.e., greatest spacing between centers of marks) is acceptable for satisfactory legibility and appearance quality, and conversely, the direction orthogonal or oblique to the first direction, along which greatest numeric density of marks (i.e., smallest spacing between centers of marks) is needed for satisfactory legibility and appearance quality. This may require experimentation through preparation of sample grids of representatively-sized marks arranged with varying column and row repeat distances, as would reflect the results of an actual laser marking operation following such grids, and subjective judgment reached by viewing the results. (It is also contemplated that appropriate algorithms and/or image analysis equipment and programming may be developed to assist in this task, or even completely perform it using programmed objective criteria, which can reduce or eliminate steps of experimentation and subjective judgment needed.) The determination reached will depend upon factors such as but not limited to, for example, dimensions and content of the desired print area/print assignment; alphanumeric character font style; font size and aspect ratio; character spacing in the reading direction; and line spacing in the direction perpendicular to the reading direction. Non-limiting examples of analytical approaches follow.

Alphanumeric characters are typically formed of combinations of line segments and/or curving segments, that each have a first vector component along a first direction and a secondary vector component along a second direction oblique or perpendicular to the first direction. For a simple example, the Latin script capital letter “N” in Arial font is constituted by two vertical segments each having a single vertical direction vector component, and a single diagonal segment having both a vertical vector component and a horizontal vector component. Because the aggregate total of the lengths of the vertical components is the greatest that can be identified, and because they lie in the vertical direction, the vertical direction is the dominant geometric vector direction.

Without needing to measure every single character in the subject print assignment, one may, with a high level of confidence, identify a direction along which the greatest aggregate number of vector components for all the characters used in the print assignment lies, by e.g., simple visual examination (for, e.g., relatively simple Latin script and fonts). For information conveyed in more complexly-shaped characters, one may (1) measure all of the characters in the script and font chosen; (2) obtain data concerning average frequency of appearance of each character in the chosen language of the text in the print assignment; and (3) calculate a weighted average of first direction vector components and second direction vector components for the characters, and thereby (4) identify the dominant geometric vector direction as the direction in which the greater value exists. In another alternative approach, one may (1) determine the aspect ratios (vertical height/horizontal width) of all of the characters in the alphabet, script and font chosen (assuming the dominant direction will be either vertical or horizontal) and again, (2) obtain data concerning frequency of appearance of each character in the chosen language of the text in the print assignment, and (3) calculate a weighted average aspect ratio for all of the characters. In this latter approach, if the weighted average aspect ratio of the characters is greater than 1, then the aggregate value of the vertical geometric vector components is highly likely to be greater than the aggregate value of the horizontal vector components. Accordingly, the dominant geometric vector direction is highly likely to be vertical.

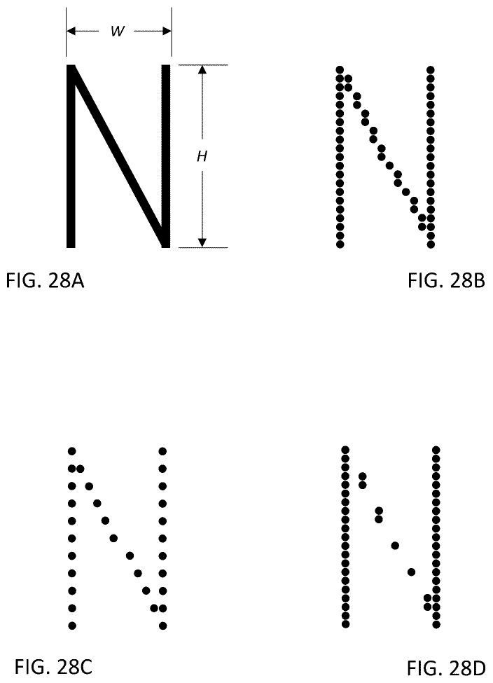

To illustrate, referring to FIG. 28A, suppose that the example single Latin character “N” in non-italicized Arial font, as printed in 12-point pitch, has a vertical height H of 3 mm and a horizontal width W of 2 mm. The character has 3 segments: 2 vertical, and 1 slanted. The 3 segments have 3 respective vertical geometric vector components, the aggregate total length of which is 3×3 mm=9 mm. Only the 1 slanted segment has a horizontal geometric vector component, the length of which is 1×2 mm=2 mm.

The aspect ratio of the character is 3 mm/2 mm, i.e., 1.5.

Suppose for purposes of discussion that the above analysis and result is substantially representative for all alphanumeric characters in the print assignment. With this assumption, the aggregate total of vertical geometric vector components for all characters will be greater than the aggregate total of horizontal vector components for all characters, and the average character aspect ratio is greater than 1.

As a resulting conclusion, under both analyses, the dominant geometric vector direction will be the vertical direction, and the subordinate geometric vector direction will be the horizontal direction.

Without intending to be bound by theory, it is believed that one may lay out a grid with columns oriented along the dominant geometric vector direction, and rows oriented along a subordinate geometric vector direction perpendicular or oblique to the dominant geometric vector direction. One will thereby have determined that one may space the rows farther apart than the columns, to reduce the number of grid locations, while preserving legibility.

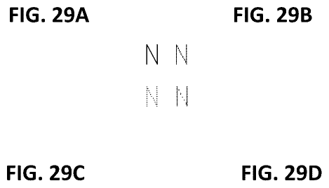

To illustrate in a simple example, FIGS. 28A-28D depict enlarged images of the Latin script capital letter “N” in a simple Arial font, printed in an analog form (FIG. 28A), e.g., via ink printing, and in digital forms, via marks arranged in regularly-spaced locations within a grid (FIGS. 28B-28D). FIGS. 29A-29D depict the same images, respectively, reduced in size to approximately 16 point.

The spacing of the rows and columns of the grid in FIG. 28B is equal. Looking at its reduced-size counterpart in FIG. 29B, it may be appreciated that the letter “N” remains quite legible.

In FIGS. 28C and 29C, half of the grid locations have been removed, by doubling the vertical direction (row) spacing, thereby halving the number of grid locations that would be required to be swept. Looking at FIG. 29C, it may be appreciated that the letter “N” still remains quite legible when substantially reduced in size.

In FIGS. 28D and 29D, half of the grid locations have been removed, by doubling the horizontal direction (column) spacing, thereby, also, halving the number of grid locations that would be required to be swept. Looking at FIG. 29D, however, it may be appreciated that the letter “N” has compromised legibility due to a perceivable loss of visual clarity/distinctiveness of the diagonal leg of the character. Without intending to be bound by theory, it is believed that this is the visual effect of taking away detail along the subordinate direction (in the example of FIG. 28D, the horizontal direction), associated with portions of characters having vector components with the lesser length value. The legibility-compromising effect becomes worse for any particular character, as the dominant direction vector component of a particular character segment becomes smaller, and is most severe when the dominate direction vector component of the particular character segment is zero. For example, in Arial font, the horizontal segments in characters including capitalized Latin characters A, E, F, G, H, L, T and Z, and Arabic numerals 2, 4 and 7, lose needed, distinguishing visual detail, and as a result, the characters/numerals will more quickly become less readily/easily recognizable, as column spacing is increased. It can be appreciated that one would have more flexibility to increase row spacing in these circumstances.

Based on this analysis, it is believed that the direction of largest aggregate total of the geometric vector components of the alphanumeric characters in a print assignment (the dominant geometric vector direction) identifies the direction along which a relatively larger repeat spacing of marks will be acceptable while retaining legibility and desired quality of appearance. One may configure the grid by aligning the orientation of one of either rows or columns to constitute the grid, along the dominant geometric vector direction. Then, one may maximize a first spacing of the other of the rows or columns, i.e., those perpendicular or oblique to the dominant geometric vector direction, to an extent to which minimum legibility/resolution/appearance quality is reached. This maximizes allowable row or column spacing measured along the dominant geometric vector direction.

Then, one may maximize a second spacing of the rows or columns that are aligned with the dominant geometric vector direction, to an extent to which minimum legibility/resolution/appearance quality is reached. This maximizes row or column spacing measured along a direction perpendicular or oblique to the dominant geometric vector direction. However, as reflected by the analysis above, The second spacing will be different, and less than, the first spacing.

This process enables configuration of an efficient grid layout, that minimizes the number of locations of a suitable grid that must be swept, and thereby minimizes the number of sweeps required to execute the print assignment.

While alphabet scripts such as, for example, the Latin and Cyrillic scripts, in often-used fonts, may often have dominant geometric vector directions that are vertical, it may be appreciated from the discussion above that the direction of largest aggregate total of vector components of alphanumeric characters in the print assignment (i.e., the dominant geometric vector direction) is not necessarily horizontal or vertical, in all cases. For example, if a predominant portion of the alphanumeric text in the print assignment appears in italics, the largest aggregate total of vector components of alphanumeric characters (along the dominant geometric vector direction) in the print assignment may be diagonal (with respect to horizontal and vertical directions), oriented along the direction of the slant of the italicized material. In such a case, it might be desirable to arrange columns of a grid oriented in such slanted direction. Similarly, it may be appreciated that a subordinate vector direction need not necessarily be perpendicular to the dominant geometric vector direction, but may be otherwise oblique to it.

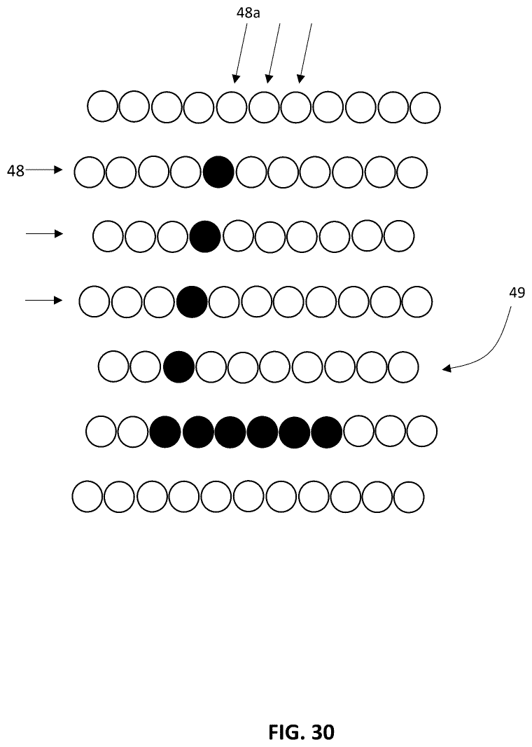

To illustrate, consider the italicized Latin character “L” in simple Arial font. Assuming (without further analysis, for purposes of discussion) that such character “L” is reflective of the dominant and subordinate vector directions of the entire alphabet used and of the subject print assignment (which may be reasonable assumption, since italicization generally slants vertical segments of characters but does not affect orientation of horizontal segments, then one might identify the dominant geometric vector direction as that of the slant of the vertically-oriented segments, and the subordinate vector direction as that of the horizontally-oriented segments. Then, an offset grid 49 might be arranged with rows 48 and slanted columns 48a, as reflected in FIG. 30. (Compare FIG. 4 and associated discussion, above.) Because the direction of the slant is the dominant geometric vector component direction, according to the discussion above, one might choose to reduce the number of marking locations along that direction (i.e., increase row spacing) to reduce the number of target focus point sweeps needed to sweep the entire grid, while still preserving legibility.

It has been discovered that, through the analytical processes described, one can determine that one of the column or row spacings in the grid may be different, i.e., greater than, than the other of the column or row spacings.

Next, a sweep direction is chosen via identification of either (1) the sweep direction that requires the smaller number of turnarounds to sweep all locations in the grid, i.e., the smaller number of times that the beam guiding equipment is required to reverse the direction of the beam target focus point as it executes successive sweeps of all rows or columns of the selected grid; this will be the direction along which the greater of the number of rows, or number of columns, would be traversed, during a sweep of the target focus point; and/or (2) the direction along which the greatest average number of laser pulses (effecting marks) are to be emitted during the sweep. In the latter case, the laser system may be controlled such that, when a series of consecutive void locations is encountered along a single sweep path, the sweep is accelerated beyond the designated constant surface velocity over the series of void locations, then decelerated back down to the designated constant surface velocity when the next location in the path to be marked is approached. In this manner, where one or more series of a plurality of consecutive void locations are present between mark locations along a sweep path, the time for that sweep may be reduced by more rapid traversal of the sweep over the void locations. This is explained in greater detail in, e.g., U.S. application Ser. No. 17/963,214.

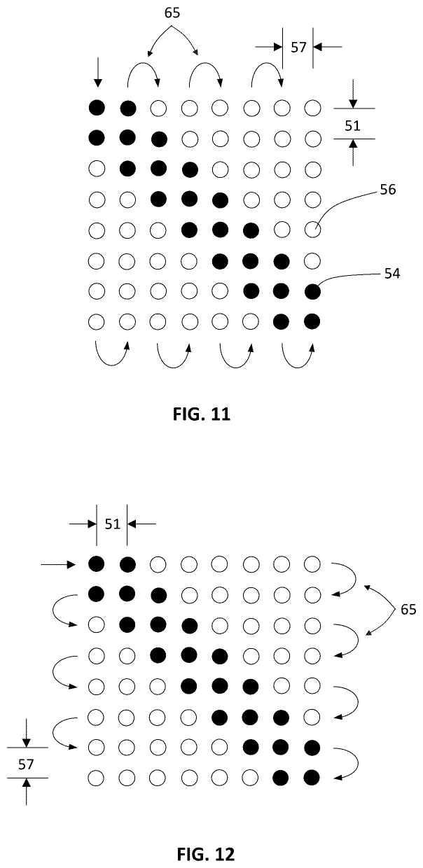

The steps described above may be illustrated with reference to FIGS. 11-16. These figures are expanded views of small portions of a larger grid that may encompass a given print assignment. The diagonal arrangements of marks shown in FIGS. 11-16 might be, for example, a portion of the slanted leg portion of the capital letter “N”. Referring to FIGS. 11 and 12, a hypothetical example of square sample portion of a grid, that might encompass a print area on an article, may be arranged wherein column and row repeat distances 51 and 57 of the grid locations, are equal, such that the individual locations are equally spaced along the directions of the rows and columns. The unit cells, reflected in FIGS. 11 and 12, as defined above, are square. The numeric density, i.e., spacing, of mark/void locations (54, 56) in the grid is the same in both directions. The number of rows in the small portion shown is equal to the number of columns. In this example, the number of turnarounds 65 of the beam target focus point sweep necessary (seven) is the same, regardless of whether the chosen sweep direction is vertical or horizontal (with respect to the figures). Thus, if sweep velocity is the same in either direction, marking/time efficiency is substantially the same, regardless of the choice made for assignment of the beam target focus point sweep direction. If the diagonal configuration of marks shown in the grid locations is a portion of, e.g., an image or alphanumeric character (such as the letter “N”), the number of beam sweeps through the grid necessary to impart the marks is the same, regardless of whether the sweeps are made along columns or along rows, i.e., regardless of the chosen sweep direction—as is the required number of turnarounds 65—in the example shown, seven.

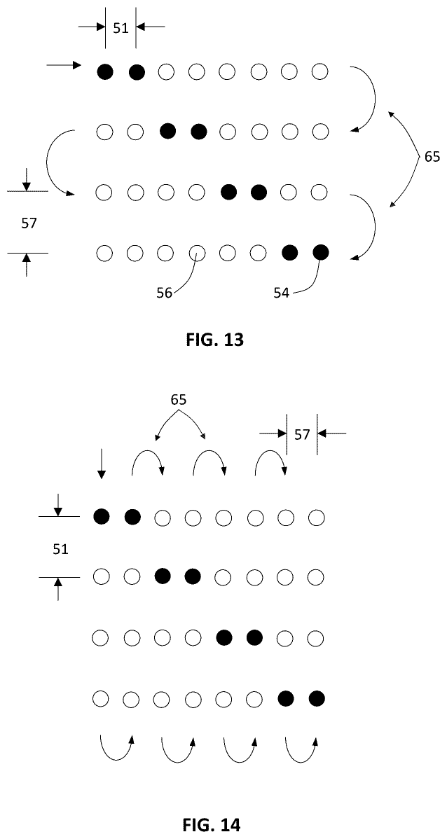

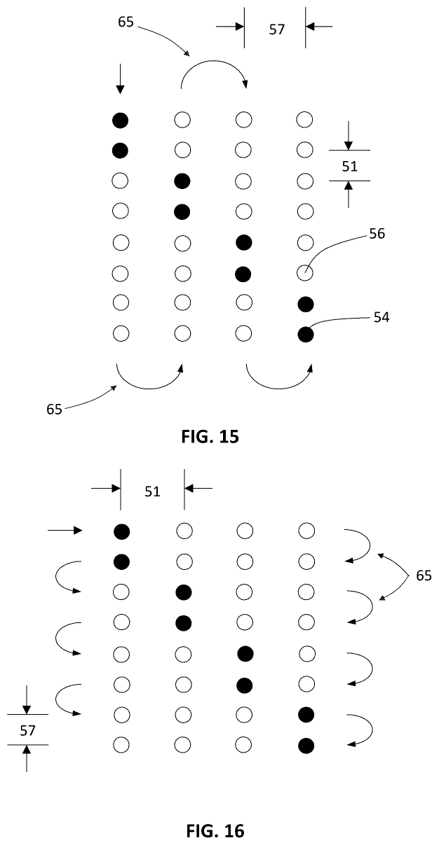

It has been discovered, however, that it may be a rare situation in which grid locations cannot be reduced in numeric density (i.e., spaced at relatively greater distances apart) along one direction of the grid rows/columns as compared with the other (perpendicular or oblique) direction of the grid rows/columns, while still retaining satisfactory legibility and/or resolution/appearance quality. For example, beginning with the square sample portion of a grid illustrated in FIGS. 11 and 12, for a given print assignment, one can likely learn, through experimentation and/or analysis such as described above, that the number of grid locations may be reduced, in the hypothetical non-limiting example illustrated, halved, by removing grid locations and making the repeat distance along one direction twice as much as the repeat distance along the other (perpendicular or oblique) direction. Experimentation and/or analysis may reveal permissible reduction of the number of grid locations along a vertical direction as reflected in FIGS. 13 and 14, or along a horizontal direction, as reflected in FIGS. 15 and 16. In the hypothetical examples illustrated, upon analysis, it may be determined whether the approach reflected in FIGS. 13 and 14, or alternatively, the approach reflected in FIGS. 15 and 16, yields the more satisfactory result, with respect to legibility and quality of appearance of, e.g., alphanumeric characters. Reduction of the number of grid locations needed for a given print assignment, via increase in a repeat distance of rows or columns, will necessarily decrease the number of rows or columns, i.e., increasing spacing between columns means fewer columns; increasing spacing between rows means fewer rows.

Following this step of minimizing the number of grid locations needed for the print assignment, the sweep direction is selected as the one in which the fewest turnarounds 65 are required to sweep the entire grid encompassing the print assignment. Among the hypothetical examples shown in FIGS. 13 and 14, choosing the sweep direction to be horizontal with respect to the figure, i.e., along rows, will provide for faster printing because fewer turnarounds 65 (three rather than seven) are required (FIG. 13). Among the hypothetical examples shown in FIGS. 15 and 16, choosing the sweep direction to be vertical with respect to the figure, i.e., along columns, will provide for faster imprinting because fewer turnarounds 65 (three rather than seven) are required (FIG. 15).

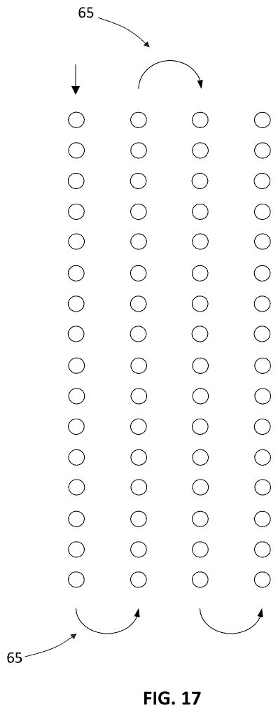

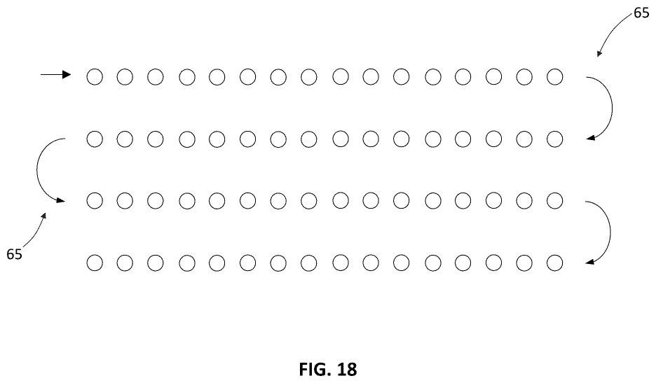

FIGS. 17 and 18 depict two hypothetical examples of rectangular portions of larger grids, that might encompass a print area on an article.

FIG. 17 reflects a determination that the repeat distance along horizontal rows may be greater than the repeat distance along vertical columns, while retaining desired levels of legibility and/or quality of appearance. The sweep direction is selected as the vertical direction, because this requires the lesser number of turnarounds 65 (three) as the laser beam target focus point is guided to sweep the entire grid.

FIG. 18 reflects a determination that the repeat distance along vertical columns may be greater than the repeat distance along horizontal rows, while retaining desired levels of legibility and/or quality of appearance. The sweep direction is selected as the horizontal direction, because this requires the lesser number of turnarounds 65 (three) as the laser beam target focus point is guided to sweep the entire grid.

From the foregoing, it can be appreciated that, to make most efficient, therefore fastest, use of the pulsed laser system to mark within a grid, it may be desired to choose a sweep direction by which the beam target focus point moves over the greatest possible number of grid locations to be processed (by effecting a mark, or leaving a void, in each location) in a single sweep, on average for all sweeps. During a sweep, the pulsing laser, gating system and guidance equipment are processing locations in the grid by emitting pulses, to effect marks on the article markable surface, or withholding pulses, to leave voids, along the sweep direction. During turnaround travel, the system is not engaged in processing locations on the grid, but rather, the beam guidance equipment (including the X-Y galvo set) is executing deceleration along the sweep direction from constant sweep velocity, shift of the beam target focus point along the perpendicular or oblique direction to the next adjacent sweep path, reversing direction of sweep, and accelerating along the sweep direction back to constant surface velocity in the reversed direction, in preparation to sweep the target focus point along the next, adjacent sweep path—this turnaround is, in effect, unproductive motion and unproductive time.

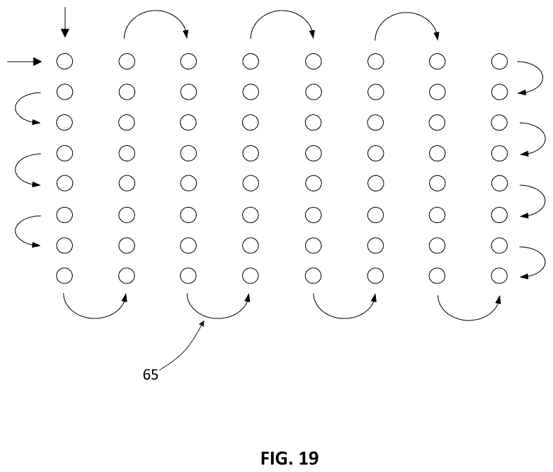

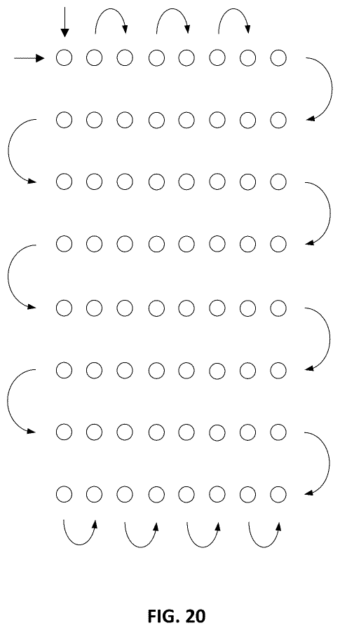

Depending upon the shape and dimensions of the print area and other factors, it is theoretically possible that increasing the repeat distance of columns or rows for a given grid shape (i.e., reducing the density of mark locations along one of the horizontal or vertical directions) will result in a grid requiring the same number of turnarounds regardless of whether the sweep direction is horizontal or vertical. FIGS. 19 and 20 illustrate examples, in which seven turnarounds are required regardless of choice of sweep direction. In the portions of grids shown, the number of turnarounds required to sweep all rows and columns of the grid (seven) is the same, regardless of whether the sweep direction is vertical or horizontal.

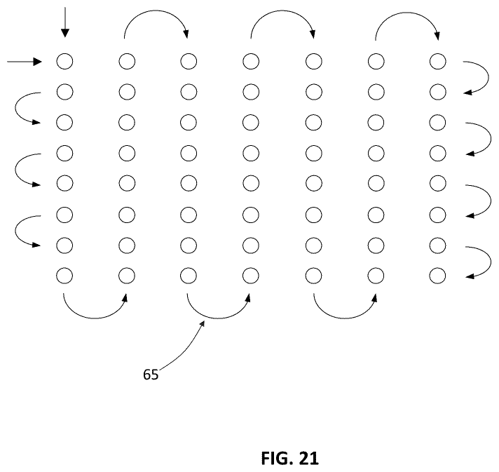

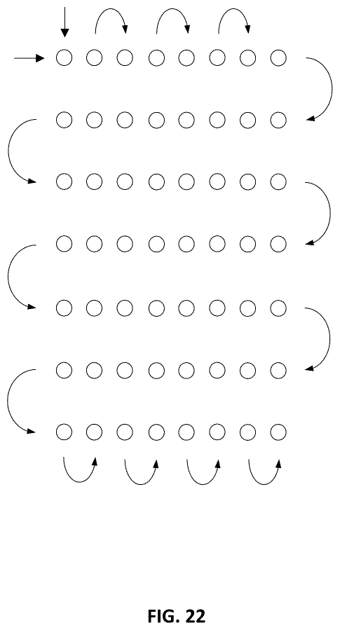

Nevertheless, a reduction in the number of rows or columns of the grid required to mark the article with satisfactory legibility and appearance quality will reduce the number of marking sweeps required, and thereby reduce cycle time. FIGS. 21 and 22 depict portions of grids similar to those of FIGS. 19 and 20, except that one column (FIG. 21) or row (FIG. 22) of grid locations has been removed. As may be appreciated from comparison of FIGS. 21 and 22 to FIGS. 19 and 20, where the number of rows or columns of marking locations is decreased via lesser numeric density and/or greater repeat distance spacing along either the horizontal or vertical directions, the number of turnarounds 65 required for sweeping in the perpendicular direction may be decreased as well (in the examples shown, from seven to six).

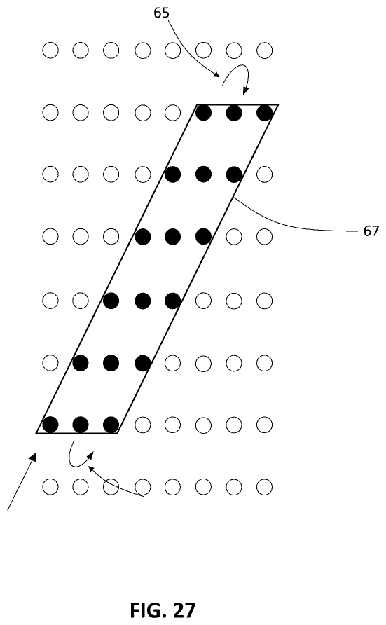

Depending upon the particular print assignment presented, it may be possible in some examples for the most efficient sweep direction to differ from both the column and row direction orientations in the grid. Referring to FIG. 27, to illustrate, a particular print assignment may require an arrangement of marks that can be swept most efficiently along a direction oblique to the orientation directions of both the columns and rows of the grid. In the illustration in FIG. 27, the number of turnarounds is only two, when the sweep direction is selected to follow the orientations of identifiable series of marks in which the greatest average number of marks per sweep may be effected, rather than one of the directions of orientation of the rows and columns. As described further below, the grid need not be laid out to effect sweep over unprinted or “white” space to the outside of the printed material. Thus, the grid may have a conforming outline 67 that delimits the required length of each sweep and thereby avoids unnecessary sweep time.

To summarize, for a given print assignment and layout thereof, including alphanumeric text and/or graphic image(s) as they are intended to appear on an article, without intending to be bound by theory, it is believed that identifying the most time-efficient marking process involves one or more of the following steps:
Where a substantial or majority portion of the area to be printed will be occupied by verbal and/or numerical information conveyed via alphanumeric characters, determine the dominant geometric vector direction of the alphanumeric characters in the print assignment;
Determine the minimum numeric density of marks needed along a first direction (i.e., maximum allowable mark repeat distance in the first direction), to provide satisfactory legibility and quality of appearance of the text and/or graphic image(s) in the print assignment;
Determine the minimum numeric density of marks needed along a second direction orthogonal or oblique to the first direction (i.e., maximum allowable mark repeat distance in the second direction), to provide satisfactory legibility and quality of appearance of the text and/or graphic image(s) in the print assignment;
Arrange a grid of locations encompassing the print assignment, wherein rows and columns of the grid define individual locations having repeat distances along the first and second directions corresponding to the respective maximum allowable mark repeat distances along the respective first and second directions, determined in the preceding two steps;
Select the beam target focus point sweep direction as that which will enable sweep of the beam target focus point over all of the locations in the grid, with the fewest turnarounds and/or enable sweep of the beam target focus point over all of the locations in the grid with the maximum average number of pulses/marks effected per sweep.

Additionally, unprinted or “white” space extending uninterruptedly along an entirety of a print area along a chosen sweep direction (for example, unmarked spaces between horizontal lines of alphanumeric text, when the sweep direction is horizontal) may be skipped over, i.e., it is not necessary to sweep the target focus point over such space, since no marks are required in that space along the sweep direction. Similarly, the grid need not be rectangular. The grid may be arranged to bound and encompass only the print assignment as presented, and X-Y galvo set controlled such that it sweeps paths only within the boundary of the print assignment.

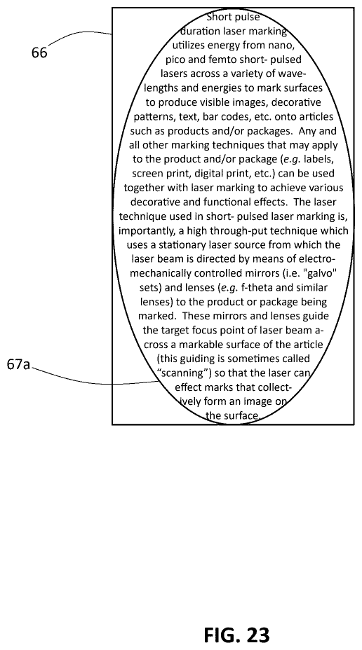

To illustrate, referring to FIG. 23, a non-limiting example of a print assignment may include a passage of alphanumeric text arranged within a generally elliptical boundary, for example, as shown. If the grid utilized were to have a rectangular outline 66, the target focus point would have to be swept along the entirety of the rectangle area, including the white space outside the actual text. This would unnecessarily consume time required to sweep over the white space. To eliminate this wasted time, the grid may be arranged with a generally conforming outline 67a, that, in the non-limiting example depicted, traces an elliptical boundary about the text.

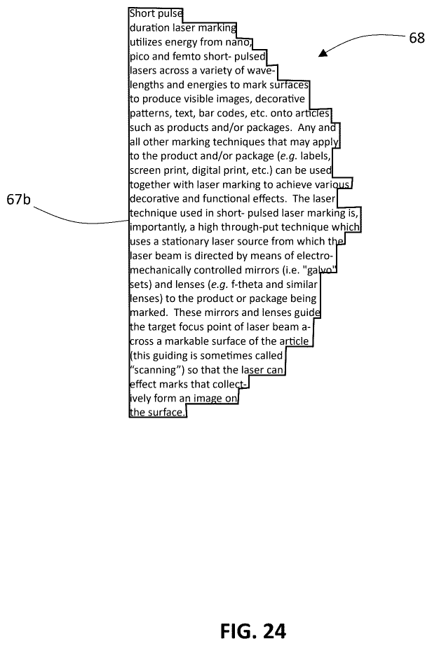

Similarly, referring to the text arrangement shown in FIG. 24, rather than creating a grid outline generally circumscribing the text arrangement, the grid may be arranged with a specifically conforming outline 67b that eliminates a need to for the target focus point to be swept over white space preceding or following each line of text. The specifically conforming outline 67b may include any appropriate number and shape of print assignment conformities 68 that closely outline the material in the print assignment as arranged.

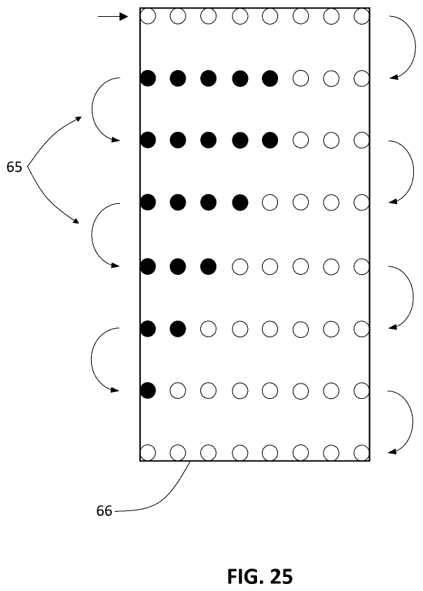

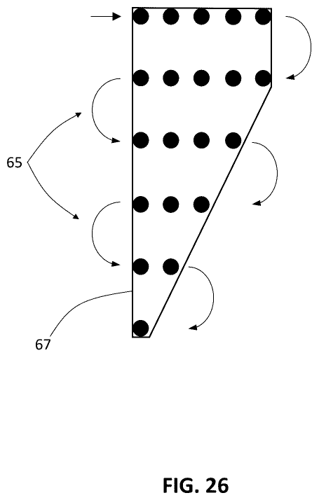

The effects of skipping over regions of white-space extending through the print area along the sweep direction, and use of such a conforming grid outline, may be appreciated with reference to FIGS. 25 and 26, which illustrate the effects at a closer level. In both figures, the arrangement of mark locations (shown as black spots) is the same. In FIG. 26, however, the number of turnarounds 65 required, and the number of rows to be swept, have both been reduced by elimination of grid locations in white space regions, as has the total required sweep distance. Eliminating unneeded sweep and turnarounds in this manner can reduce cycle time.

### Additional Laser Marking Rate Improvement Measures

As discussed, use of techniques contemplated herein can enable laser marking of articles faster and with more precision than prior processes. Existing raster processes are relatively slow, but relatively accurate, while vector laser marking processes are relatively faster and accurate at low speeds but relatively imprecise at high speeds, resulting in imprinted characters or other marked images that may have poor appearance quality, poor human legibility and/or poor machine readability (e.g., for bar codes). Raster and vector are different graphic file types that require different modes of laser processing. The main differences between the techniques of each type involve the movement of the galvos that guide the laser beam, and in the parameters used.

The vector path typically is slower for images because of the multiple fixed short start and stop points that require the galvo set to spend time accelerating to a user set maximum surface velocity (determined by the repeat distance multiplied by the pulse repetition rate) and the length of the vector distance. Lengthy vector distances allow the vector pulsed laser system to reach its maximum surface velocity, while shorter vector distances have the pulsed laser system constantly accelerating and decelerating and never reaching the maximum surface velocity, resulting in longer marking cycle times.

The vector process is also less precise than the CV-bitmap process at high speeds, due to the acceleration/de-acceleration of the galvos guiding the laser beam. Specifically, the location of each laser mark must be communicated from a computer driven software to the laser marking apparatus and such communication must be updated during the marking of the predetermined pattern, for example, as the laser beam traverses a given row. Typical update frequencies for this communication are ˜10 μs, so a laser outputting pulses with a repetition rate of 100 kHz would allow for an update in the communication for each individual location in the grid. This is also true of raster laser marking processes, which may further include variation of the pulse power for each pulse as a means of achieving grayscale (e.g., dithering). As the velocity of the laser beam movement across the surface of the article increases, repetition rates of greater than 100 kHz are required to achieve the desired mark spacing, and each update from the software must now communicate the location of multiple laser marks (or voids/non-marks). While the calculations can be performed nearly instantaneously, it is believed that in the extremely fast time-domains of high-speed laser marking, the galvos cannot respond as quickly, and the accelerate/de-accelerate profile of the vector process results in a significant number of misplaced marks within a given row, versus the constant surface velocity technique contemplated herein.

FIG. 6B depicts the effect of running a vector-type process at high speed when marking text involving alphanumeric characters and the misplacement of marks within a row. The figure shows misplaced marks resulting from marking initiating too early or too late, so that the outline of the alphanumeric character is jagged and the overall appearance is blurred, of unacceptable appearance quality, and potentially illegible (e.g., one cannot distinguish an “8” from an “0”).

In contrast, the process and resulting markings contemplated herein can be imparted by a constant surface velocity (CV) bitmap path. The CV-bitmap laser marking process allows for increased speed and increased precision because there are no start and stop points within a row or column to be marked, but rather, a user-defined maximum surface velocity (again, the repeat distance multiplied by the pulse repetition rate) that is constant while as the beam sweeps the row or column and emits or withholds marking pulses. Moreover, the pulsed laser system contemplated herein can increase beam guidance speed when the beam is not marking over a relatively long distance (relative to the repeat distance in the sweep direction). For example, if there is a distance of 2-3 mm (or more) between centers of marks in one row, the pulsed laser system can accelerate to a greater speed without losing accuracy; otherwise, during marking, the laser beam is moved at a constant surface velocity while pulsing. This is yet another reason the marking systems and techniques of this disclosure are faster and more accurate than prior systems and techniques.

Relatively smaller galvo sets (i.e., sets having relatively lower mass mirrors) have less inertia and thereby enable relatively greater acceleration to reach this user-defined maximum surface velocity. One can tune these galvo sets to relatively high acceleration values that allow the mirrors to reach their desired angular velocity in a lesser amount of time. Interestingly, these values can be tuned specifically for bitmap processing at higher values, as compared to vector processing. Additionally, in vector laser control software there is a maximum marking surface velocity limitation set such that the laser marks are close to their desired commanded position. As one increases the maximum surface velocity threshold in vector processing, the laser pulse target points exhibit more error with respect to their intended positions. In CV-bitmap marking mode, since the surface velocity (e.g., both the angular velocity of the mirrors and the surface velocity of the laser beam sweep) is constant during the marking process, one can increase the maximum surface velocity threshold significantly achieving an overall lower marking cycle time as compared with vector processing, and still maintain firing of pulses at the target positions intended.

The mass of X-Y mirrors and mechanical limitations of associated galvo motors impose mechanical limitations on acceleration and deceleration of the target focus point required during, e.g., turnarounds. However, it has been learned that these limitations may be substantially mitigated via extension of the focal length and working distance. As focal length is increased, the surface velocity of the target focus point is proportionately increased: other variables being held constant, as focal length increases, less angular movement of the mirror(s) is required to cause the target focus point to sweep along a same distance along the focal plane. Also, as focal length is increased, slower angular movement of the mirror(s) is required to cause the target focus point to sweep at a same surface velocity, and slower angular deceleration and acceleration of the mirrors is required to cause the target focus point to execute the same turnaround (other variables being held constant). Additionally, the size of the field of view is increased with increase of the focal length. As an article is moved within the field of view of a laser marking system by a conveyor at a given speed, a larger field of view provides a greater window of time for the system to execute a larger and/or more detailed print assignment, while the article to be imprinted is being conveyed within the field of view.

Thus, increasing focal length allows one to (a) increase target focus point sweep velocity/surface velocity; (b) execute turnarounds faster; and (c) take advantage of a larger field of view, within the limits of the chosen X-Y galvo set. Increasing the size of the field of view facilitates executing a print assignment of larger surface area in a single process and/or via a single laser configuration, without the need for dividing the print assignment among more than one laser configuration. Utilizing equipment currently available and configured as described herein, the field of view resulting from increasing focal length may range from 40,000 mm² to 2,250,000 mm², and thereby may be large enough to execute a print assignment via sweep of an associated grid having an area 400 mm² to 800 mm², or to 2,000 mm², or to 4,000 mm², or to 8,000 mm², or to 12,000 mm², or to 16,000 mm², or even to 20,000 mm², at conveying speeds contemplated herein.

For purposes contemplated herein, and to enjoy the advantages identified above, it may be desired to configure a laser marking system with a focal length of at least 330 mm, preferably at least 1,000 mm and more preferably at least 2,000 mm, or even more preferably at least 3,000 mm, within limits of lens that are or may be available. At any given constant surface sweep velocity, reducing angular velocity required for an X-Y galvo set to execute a turnaround in the sweep path enables choosing a tuning of certain earlier types of galvo sets that provides a faster turnaround time. In contrast, newer scanners like Scanlab EXCELLISCAN and INTELLISCAN IV can automatically change the turnaround time based on scan velocity. For both of these cases, longer focal length lens significantly reduce the turnaround time component of the process time which is made up of constant velocity, white space accelerations/decelerations and turnarounds.

Focal length may be increased via selection and use of a lens with a greater specified focal length. However, as the focal length associated with a chosen lens increases, spot size (diameter of the beam as most tightly focused in the focal plane of the lens) also increases. Increase of spot size decreases the amount of energy delivered by a beam pulse from a given laser, per unit surface area (fluence) on the target surface. Decrease of fluence reduces the efficacy of a laser beam pulse at marking the target surface, and may also reduce mark sharpness and precision.

To compensate, and thereby realize the advantages of increasing focal length as identified above, it has been learned that one may insert a beam expander in the laser beam path, preferably at a location upstream of the X-Y galvo set. With reference to FIG. 2A, this would be at a location between laser 20 and X-mirror 22. A beam expander 70 increases the diameter of the collimated beam 28. Increase of the diameter of the collimated beam that enters the lens 26 (which, as previously noted, may be an f-theta lens) reduces the diameter of spot size in the focal plane. Thus, fluence at focus point 29 in focal plane 29a may be increased by use of a beam expander, enabling effective use of a lens with a greater focal length and enjoyment of the advantages thereof, noted above, which are particularly beneficial when marking an article that is translating along a path on a conveyor.

The angular velocity of the X-Y galvo set mirrors are important to job cycle time as it relates directly to the laser beam's surface velocity across the article. The surface velocity of the laser beam is set by the angular velocity of the X-Y mirror pair and the specified focal length of the lens used.

$$surface velocity = galvo angular velocity ( rad / sec ) * focal length ( mm )$$

In some examples, the surface velocity of the target focus point during a sweep along a given row or column may, with appropriate setup, be controlled by the X-galvo/mirror set. In this circumstance, job cycle time can be more dependent on the laser surface velocity in the sweep direction than in the perpendicular or oblique direction, and the X-galvo/mirror set may be chosen so as to be more responsive than the Y-galvo/mirror set. For example, the mirror on the X-galvo/mirror set may be chosen to be smaller (i.e., lower mass, smaller mirror size, lower inertia, higher acceleration motor capability) than the Y-galvo/mirror set. In the event a sweep direction is chosen for a particular print assignment that requires rotation of the galvo system to orient the X- and Y-mirrors correctly for the particular assignment, that may be accomplished during setup.

The usable surface velocities (sweep velocities) of the laser beam target focus point sweep across the focal plane in the current CV-bitmap process are much greater than those achievable with currently available laser marking processes such as raster and vector marking processes. Current processes typically exemplify surface velocity on the order of 8 m/s or less. The CV-bitmap process contemplated herein provides for surface velocities above 8 m/s, and further, surface velocities equal to or greater than 10 m/s, 15 m/s, 18 m/s, 22.5 m/s, 32.5 m/s, 45 m/s, 60 m/s, 90 m/s, or even 200 m/s, and are expected to go higher with improvements in pulse laser technology.

Control of the direction of the sweep path of the laser beam target focus point across the focal plane can also contribute to reduced cycle time. A conventional raster laser marking process sweeps the laser beam across rows in either of right-to-left or left-to-right progress directions, but not both (known as a “unidirectional” process), and at the completion of a row at one end, returns the beam to the other end of the next row in a manner analogous to that of a carriage return on a typewriter. In this way, subsequent rows can be easily registered (i.e., stacked) and grid locations can be aligned based on this consistent starting line. To eliminate the return distance travel and thereby reduce the time required to sweep each row (or column), the current CV-bitmap process uses a “bi-directional” process in which marking may be done in back-and-forth progress directions (e.g., sweep occurs left-to-right in a first row and right-to-left in a next row).

To keep the rows or columns of marking pulses aligned, the pulsed laser system may be programmed to incorporate a laser-on-adjust which is a delay function for each alternating row or column.

The laser-on-adjust is an element of the turnaround profile of the target focus point sweep path. The turnaround profile refers to the guidance path executed by the X-Y galvo set directing the target focus point path to shift and reverse direction proximate the ends of adjacent rows or columns (e.g., after a sweep processing a row left-to-right, decelerating from specified constant velocity to zero in the left-to-right sweep direction, shifting beam target focus point to the next row of the grid, and accelerating in the right-to-left sweep direction to specified constant velocity to sweep and mark the next row right-to-left). The laser is typically off (i.e., not emitting pulses) during the turnaround. The laser-on-adjust facilitates alignment of pulses and effected marks within adjacent rows or columns. For example, when the grid is a stacked grid, the laser-on-adjust ensures that the marks in adjacent rows remain stacked. If an offset grid is used, then the laser-on-adjust will help ensure that the grid remains offset, and that the amount of the offset remains sufficiently constant. The laser-on-adjust value may be determined experimentally, and generally, may vary with angular velocity of the galvo sets.

The profile of the turnaround of laser beam path after sweep of a row or column can also help reduce cycle time. As discussed previously, the laser beam focus is guided along the article surface by an X-Y galvo set, and the rate at which a galvo and mirror can accelerate and decelerate angularly is a known limitation to speed and accuracy of laser marking in other (e.g., vector) marking processes. The current CV-bitmap process helps overcome this limitation. The current CV-bitmap process does not effect acceleration or deceleration of the laser beam target focus point while the laser is emitting pulses (i.e., imparting marks on the article). Instead, the target focus point is only accelerated and decelerated while the laser is not pulsing, such as, for example, when the target focus point is skipping multiple voids (or even entire rows), or when the target focus point is being reversed and shifted at the completion of a row, in preparation to sweep and mark along a subsequent row. The turnaround profile may be symmetric or asymmetric. Given the high speeds at which the laser beam sweeps across the surface of the article, an asymmetric turnaround profile may be preferred.

As discussed, changing grid location spacing can affect cycle time. As discussed, spreading out the locations within the grid (i.e., increasing the row and/or column spacings) can enable a decrease of cycle time. Increasing the repeat distance along a sweep reduces cycle time in that the surface sweep velocity is a factor of the laser repetition rate and the repeat distance. Increasing the other of the row or column spacings can reduce cycle time by reducing the number of turnarounds that the galvo sets are required to execute, which may take up to 30-70 percent of the total cycle time at high surface velocities. In some examples, one might be able to reduce the column spacing and increase the row spacing to get an acceptably-similar quality image at a reduced overall cycle time. It has been discovered, that for any particular grid, reducing one of the row or column spacings-concurrently with leaving the other unchanged, or increasing it, can enable faster cycle time for a given print assignment.

As discussed, appropriate selection of row and column spacings and their ratio can contribute to laser marking legible small font text or images at high speed (i.e., low cycle time). Row and column spacing can also be important when marking images such as graphics, particularly when the image(s) include grayscale. Whereas the known process of raster marking creates grayscale by varying the energies of individual laser pulses, the CV-bitmap process instead runs too fast and does not vary these pulse energies individually. The CV-bitmap process may be used to emulate grayscale printing by appropriately spacing full energy pulses and resulting marks in appropriate patterns to impart a grayscale appearance.

In the laser marking process contemplated herein, the laser source may be kept stationary, and the laser beam may be guided by the pulsed laser system including a series of lenses and mirrors which are controlled by an algorithm, so as to execute the print assignment with relatively high speed. The algorithm is able to read a digital image of the desired print assignment (e.g., from a PDF file of the desired image) and translate the image to a suitable arrangement of marks, in locations within a grid, such as will provide a reproduction of the print assignment with satisfactory legibility and appearance quality on the subject article surface. Examples of a suitable lens/mirror systems and algorithms may currently be obtained from IPG Photonics, Oxford, Massachusetts, USA, or laser processing modules available from LasX Industries, Inc., White Bear Lake, Minnesota, USA.

### Packeting

One way the currently contemplated constant velocity (CV)-bitmap process can overcome the 10 us limit update rate is to include multiple individual instructions in one packet of instructions to the pulsed laser system. That is, a packet may include individual instructions for each of a plurality of potential laser pulses at the pulsed laser's particular repetition rate, to pulse or not to pulse, in a single update that results in the laser emitting a pulse creating a mark, or omitting a pulse leaving a void. In such a process, each row may contain marked and unmarked locations according to the packet of instructions.

The constant velocity of the laser beam target focus point sweep provides that the sweep direction distance within these chains of multiple pulses (or withheld pulses) will remain consistent. Recalling that the target focus point sweep speed along the focal plane is determined as:

$$Repeat distance \times repetition rate = surface velocity$$

increasing the repetition rate of the laser from 100 kHz to 200 kHz doubles the surface velocity, and thereby can contribute to reducing cycle-time.

Including multiple individual instructions in a single update can also be used to enhance the resolution and/or intricacy of detail of the printed image to be effected. While a laser marking process that includes only one pulse per update (i.e., employing the 10 us update rate and a 100 kHz repetition rate laser) can produce intricacy to a single mark or void on the article markable surface corresponding with individual grid locations, such as:
mark-void-mark-void-mark-void
   the same process employing a 200 kHz laser would have twice the target focus point sweep speed but could only produce such detail on the markable surface as:
mark-mark-void-void-mark-mark-void-void-mark-mark-void-void

The target focus point sweep speeds across the grid enabled by the CV-bitmap process contemplated herein are much faster than those achievable with currently available laser-marking processes such as raster and vector marking processes.

The packets of individual instructions defined herein may be communicated to the pulsed laser system at regular time intervals, such as every 10 μs. The packets of individual instructions defined herein contain pulse/no pulse information as described above but may also contain additional instructions in each packet. For example, a packet of information might include individual instructions related to position of the locations at which pulses will be directed. To increase the speed and accuracy of the overall pulsed laser marking process, it desirable to do two things. First, each packet of information should include the maximum number of individual instructions that the processor will allow, and second, the number of instructions related to pulses/no pulses, should be maximized with respect to other instructional information in the same packet.

To illustrate the packeting concepts contemplated herein, one might think of a packet as a vehicle such as a bus. There might be, for example, 2, 4, 8, 16, 32, 64 or more, seats on a given bus. Driving a bus with 16 seats from point A to point B, with only 4 people on board, is an inefficient use of the bus. Just as filling each of the 16 seats of the bus with a passenger, filling each packet of information with the maximum number of individual instructions that the processor will allow will increase efficiency.

The pulsed laser marking processes contemplated herein operate with a constant pulse repetition rate and a constant surface velocity when sweeping the laser beam target focus point over a given row or column of locations in the grid, with a brief deceleration/re-acceleration process at the turnaround following the end of the sweep of each row or column. During this turnaround process the laser is not marking; beam pulses are not being emitted. Further, the only reversal of direction occurs, again, beyond the end of each row or column. During the brief turnaround period, the packets of instructions may include a greater amount of positional information.

Similarly, constant surface velocity and constant repetition rate provide that the locations along a selected sweep direction locations are predetermined at the outset of the sweep informed by a packet. As such, with the exception of the beginning and end of each row, the packets of individual instructions may require only one positional instruction. The positional instruction may include X-, and Y-, and Z-components. (When sweeping a target focus point along a planar focal plane, the Z-component of the position information may be consistently zero).

Because the target focus point of the pulsed laser moves at constant surface velocity over marking locations along the focal plane, the end point of the sweep informed by one packet determines the beginning point for the next packet. Thus, the one individual instruction related to position serves the dual purpose of the end location for one packet and the beginning locations for the next. Velocity is defined as distance traveled divided by the time required to travel that distance. Each packet has a set time, and the one positional instruction tells the pulsed laser system how far to sweep the target focus point, which defines the speed. Thus, no additional instructions related to speed are required, which frees computational space (“seats” on the “bus”) for pulse/no pulse instructional information. This simplification of speed and position maximizes the number of individual instructions available, relating to mark and void. This speeds up the entire process and makes it more accurate. This level of efficiency for packet use cannot be achieved with the prior art process (i.e., raster, vector) that, for example, draw borders, and then fill in between the lines. Those prior art processes require additional information concerning speed and position, within each packet of information.

Thus, a markable surface of an article can be marked using a pulsed laser system to create image(s) constituted by a plurality of marks and voids on a markable article surface, at locations on the surface corresponding with locations laid out in a grid in the focal plane. The grid is made up of a plurality of locations disposed along an arrangement of substantially parallel rows and columns, wherein each location either receives a focused beam pulse, or not, resulting in a mark on the article surface corresponding with an associated location in the grid, or a void. Beam pulses from the pulsed laser system effect the marks, and absence of (or omission of) pulses leaves the voids. The pulsed laser system is controlled by a computing device that sends packets of instructions to the pulsed laser system, the packet of instructions comprising at least 2, preferably at least 4, more preferably at least 8, and even more preferably at least 16, or even at least 32 or at least 64 or more individual instructions, wherein each individual instruction informs the laser to emit a pulse that is directed and focused on the focal plane or not, imparting a mark or leaving void, respectively, on the article at locations corresponding with each location in the grid pattern. The packets of instructions may be provided to the pulsed laser system at a 10 μs update rate (in accordance with currently standard industrial communication protocols). It is contemplated that advances in technology will increase the update rate at which the packets may be provided to the pulsed laser system may in the future be less than 10 μs, or 7.5 μs, or 5 μs, or even 2.5 μs, but as best as currently understood, this is not currently the case.

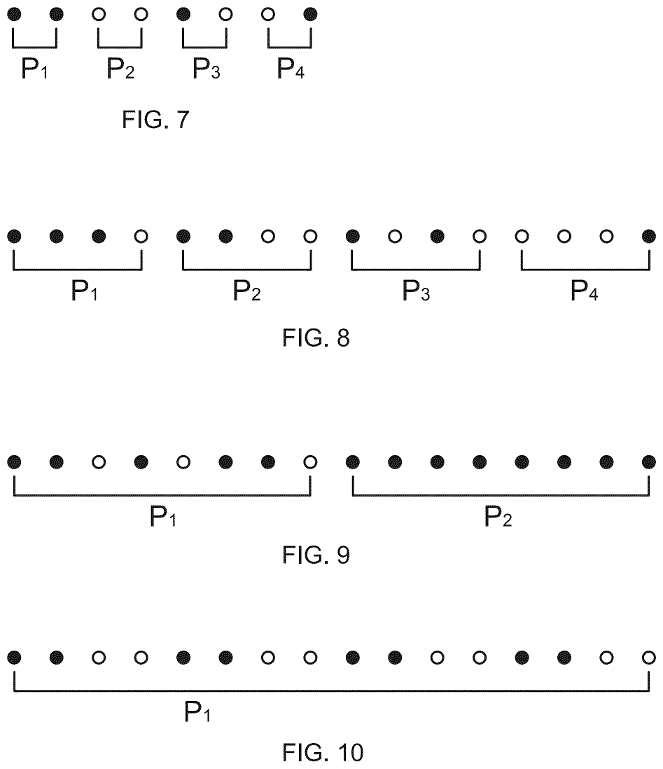

FIG. 7 is an example of one row of a grid pattern with packets P1, P2, P3 and P4 each containing 2 individual instructions to the pulsed laser system. P1 instructs the pulsed laser system to pulse twice, resulting in two marks. P2 instructs the pulsed laser system to not pulse twice, leaving two voids. P3 instructs the pulsed laser system to pulse once, then not pulse once, effecting one mark and leaving one void. P4 instructs the pulsed laser system to do the opposite of P3. This arrangement of marks and voids corresponding to locations in a grid pattern may be used to form any of a variety of images.

FIG. 8 is an example of one row of a grid pattern with packets P1, P2, P3 and P4 each containing 4 individual instructions to the pulsed laser system. P1 instructs the pulsed laser system to pulse three times and not pulse once, so as to effect three marks and one void. P2 instructs the pulsed laser system to pulse twice, then not pulse twice, effecting two marks and leaving two voids. P3 instructs the pulsed laser system to pulse once, not pulse, pulse again, then not pulse, effecting a mark-void-mark-void pattern. P4 instructs the pulsed laser system to not pulse three times then pulse once, effecting three voids and one mark.

FIG. 9 is an example of one row corresponding with one row of a grid pattern with packets P1 and P2 each containing 8 individual instructions to the pulsed laser system. P1 instructs the pulsed laser system to pulse twice, not pulse, pulse, not pulse, pulse twice, and not pulse. P2 instructs the pulsed laser system to pulse eight times. Polygon scanners of the prior art can send two or more instructions to a pulsed laser system, but the instructions are all pulse, or all not pulse. For example, a polygon scanner can send eight pulse then eight no-pulse instructions, for a single update. These polygon scanners of the prior art cannot send individual instructions according to the present disclosure. Improved versatility is achieved by controlling each and every location with a pulse, or withheld pulse, as taught by the present disclosure. Images including alphanumeric characters, graphic images, logos, UPC codes, QR codes, and the like can be formed by marks effected on surfaces with improved speed and accuracy by utilizing the individual packeted instructions contemplated herein.

FIG. 10 is an example of one row of a grid pattern with packet P1 containing 16 individual instructions to the pulsed laser system. P1 instructs the pulsed laser system to pulse two times, then not pulse twice. This pattern is repeated three more times for a total of 16 individual instructions in one packet of information.

There is further provided herein a method of marking a markable surface using a pulsed laser system comprising the following steps. First, define an image to be formed by a plurality of marks and voids in a grid, the grid comprising a plurality of discrete locations disposed along a series of substantially parallel rows. Each location is to receive a laser beam pulse, or not, to leave either a mark or a void corresponding with the location. Then, effect the marks by pulsing the pulsed laser system, and leave the voids by not pulsing the pulsed laser system. The pulsed laser system is controlled by a computing device that sends packets of instructions to the pulsed laser system, the packet of instructions comprising 2, preferably 4, more preferably 8, and even more preferably 16 or more individual instructions. Each individual instruction informs the pulsed laser system to pulse or not to pulse, leaving a mark or a void, respectively, at each location on the article surface corresponding with each location in the grid pattern.

### Laser Marking/Laser Imprinting Articles in Motion

Via experimentation with the processes and equipment for laser marking articles described above, it has been discovered that the enhanced marking speed (without substantial compromise of precision and resolution) achievable thereby can enable laser marking articles while they are in, e.g., translating or even rotating motion, e.g., moving on a conveyor constituting a component of a manufacturing and/or packaging line. The hardware and software that controls the laser beam emission, direction, path and surface velocity may be programmed to continuously adjust the X-mirrors and/or Y-mirrors that direct the laser beam, along suitable directions and at a rate that continuously adjusts for the conveying path velocity and moving position of the articles on the conveyor. (Herein, “conveyor” means any equipment configured to convey or transport articles along a one-, two-, or three-dimensional path that extends for any measurable distance, within and/or through an operably effective field of view of the lens component of the laser system-herein, the “print window”.) It has been discovered that the laser system described herein may be adapted and programmed to execute laser marking on articles in motion on a conveyor without unacceptable distortion or loss of precision of the intended printed subject matter, as enabled by the relatively short time required for such marking, i.e., due to the rapid marking speed enabled by the equipment and methods described herein.

In the simplest examples including articles having curving/contoured surfaces to be imprinted, the conveying path, as the article passes through the print window of a stationary laser system including an f-theta or flat-field lens from which the directed beam emerges toward the target focus point, may be linear (i.e., purely translational, or one-dimensional). In such examples, as noted, it may be desired that the relative positioning of the path of the passing article and the lens from which the laser beam emerges, are selected and adjusted such that the focal plane of the lens, as the equipment is positioned, divides the difference between the shortest and longest distances between the surface of the article to be marked, and the lens, through the print window. (This is discussed further, above, with reference to FIG. 2B.) Such positioning may serve to minimize distortion and/or loss of clarity of the intended marked image and/or alphanumeric text, that can result from the laser beam pulse impinging on the article surface at a location that is in front of or behind the focal plane of the lens (i.e., where the laser beam spot is not most tightly focused).

In other examples that do not include an f-theta or flat field lens, the conveyor equipment and conveyor path may be configured such that the articles follow a two-dimensional arc path about or around the stationary laser system, specifically, about the location where the laser beam emerges from the lens. In such examples, the possibility for distortion of the intended print subject matter may be further reduced, because distance between the articles and the emergent location of the laser beam from the lens may be configured to be fixed, or less changeable, than would be the case with a linear conveyor path passing a stationary laser system.

In either of the approaches described above, for added purposes of simplicity of programming and minimization of possibilities for error in mark placement or distortion of intended print subject matter, it may be desired that the path speed of the articles on the conveyor be constant, or if it changes, it changes at a rate that does not overtake the update rate at which the encoder can keep abreast of the changes in path speed through the print window.

In other examples, in order to reduce the relative change of position between the laser system and the articles being marked as they move along an article path on the conveyor, the laser system may be mounted to its own conveying equipment so as to be simultaneously moved along a laser system path that is at least partially parallel and/or tracks the article conveying path, during the marking process. In some examples, one or more laser systems may be mounted on a rotating fixture, that moves the laser system(s) along a first arc path, and the article conveying equipment can be configured to convey the articles along a second arc path along which the articles and the laser system(s) move at similar angular velocities.

In other examples which in some circumstances may be advantageous where, for example, the desired marking is relatively dense (e.g., dense text material and/or densely-spaced markings to form high-resolution graphic images), or alternatively the print assignment has a relatively large surface area, marking of a pattern on a single article, moving on a conveyor, may be performed using a series of a plurality of stationary laser systems disposed along the conveying path. In such a configuration, a first laser system may be configured to mark a first portion of the desired pattern on the article; a second laser system may be configured to mark a second portion of the desired marking pattern on the article, and so on, wherein the respective laser systems are disposed and configured to perform their respective portions of the marking in a manner such that the respectively marked portions are coordinated and/or aligned to form the desired marking pattern as a coherent whole result. In effect, each portion of the print assignment is a separate print assignment, with respect to each of the laser systems.

In other examples, a series of a plurality of stationary laser systems may be configured in series along the conveying path to divide the task of marking the passing series of articles. To illustrate, for example, a first laser system may be configured and programmed to completely mark a first article moving through a first print window in which the first laser system operates; a second laser system disposed downstream of the first may be configured and programmed to completely mark a second article that has followed the first article on the conveyor and moves through a print window in which the second laser system operates, etc. In this manner, a plurality of laser systems in series may be configured to have print windows such that the plurality of laser systems are performing respectively complete marking operations on a plurality of moving individual articles simultaneously or during overlapping time periods, thereby enabling more rapid marking of articles passing by on a conveyor.

Rather than monitor movement and speed of the article itself, it may be deemed practical and most efficient to provide and utilize an encoder to monitor conveyor speed, and feed such data to the laser control system, to enable the system to adjust marking sweeps for the movement of the article and the speed thereof. In combination, it may be desirable that the conveyor include or be associated with a mechanism configured to prevent the article from moving in any manner, relative the components of the conveyor effect conveyance of the article within the field of view for marking. This helps ensure precise and accurate marking, without errors that may result from relative movement between the articles and the conveyor.

Although the features of marking method(s) described above may in some circumstances enable a producer to avoid a need to divide the task of executing a print assignment on articles in motion into two or more portions, to be performed by two or more laser systems, such an approach is not intended to be excluded. In examples in which the desired print assignment has a relatively large surface area and/or requires relatively high resolution (i.e., relatively high number of marks per unit surface area), it may remain desirable to divide the task of executing a print assignment on articles in motion into two or more portions, to be performed by two or more laser systems. Regardless, the features of marking method(s) described above can enable such processing to be accomplished with improved speed/cycle time.

In addition to the foregoing, the disclosures of the following US patent applications are incorporated herein by reference, to the extent not inconsistent herewith: Ser. No. 17/963,214; Ser. No. 17/963,215; Ser. No. 17/987,893; Ser. No. 17/987,895; Ser. No. 18/128,341; Ser. No. 18/128,347; Ser. No. 18/128,356; Ser. No. 18/128,359; and Ser. No. 18/631,142.

In view of the foregoing disclosure, the following non-limiting examples are contemplated herein:

### A. Grid Column and Row Spacing

1. A method for marking an article with a pulsed laser to effect imprinting via the marking, while the article is in motion, the method comprising the steps of:
providing a pulsed laser system comprising a pulsed laser configured to produce laser beam pulses, a beam gating system, a beam guidance system, and a focusing lens, the focusing lens having a focal plane and a field of view;
providing an article comprising a markable surface, and a conveyor that effects motion of the article;
configuring the conveyor such that at least a portion of the markable surface is positioned proximate the focal plane as the article travels within the field of view;
providing a predetermined print assignment to be processed on the markable surface;
conveying the article and the markable surface within the field of view; and
directing and guiding a target focus point for laser beam pulses to sweep along the focal plane such that the pulses impinge upon the markable surface and effect marks on the article at a plurality of locations corresponding with discrete locations of a grid in the focal plane;
wherein the grid has an outline circumscribing the print assignment and is constituted by a plurality of columns and rows of the discrete locations within the outline, wherein at each discrete location a laser beam pulse is directed, or withheld;
wherein the rows have a first spacing and the columns have a second spacing, and the first and second spacings differ; and
wherein the sweep occurs along a sweep direction and at a constant velocity over mark locations, and wherein the constant velocity is greater than about 8 m/s, preferably greater than about 10 m/s, preferably greater than about 15 m/s, preferably greater than about 18 m/s, preferably greater than about 22 m/s, preferably greater than about 32 m/s, preferably greater than about 45 m/s, preferably greater than about 60 m/s, preferably greater than about 75 m/s, and preferably greater than about 90 m/s.

2. The method of any of the preceding examples wherein the focusing lens is a flat field lens or an f-theta lens, and preferably an f-theta lens.

3. The method of any of the preceding examples wherein the markable surface is positioned in the focal plane as the article moves within the field of view.

4. The method of any of the preceding examples wherein the guiding step causes the target focus point to sweep either successive rows, or successive columns, constituting the grid and all discrete locations thereof, wherein the sweep direction is selected as either along a direction of orientation of the rows or along a direction of orientation of the columns.

5. The method of any of the preceding examples wherein a number of turnarounds required for the laser beam to sweep over all of the discrete locations is minimized.

6. The method of any of the preceding examples wherein the average number of pulses emitted per sweep, that effect marks on the markable surface, is maximized.

7. The method of any of the preceding examples wherein the pulsed laser is held stationary.

8. The method of any of the preceding examples wherein the motion is translating motion.

9. The method of example 8 wherein the translating motion has a constant conveying speed.

10. The method of example 9 wherein the conveying speed is 0.1 m/s to 2.0 m/s, preferably 0.1 m/s to 5 m/s, and more preferably 0.1 m/s to 20 m/s.

11. The method of any of the preceding examples wherein grid outline has a surface area of 400 mm² to 20,000 mm².

12. The method of any of the preceding examples wherein the field of view has an area in the focal plane equal to or greater than 40,000 mm² to 2,250,000 mm².

13. The method of any of the preceding examples, wherein the laser beam pulses directed at the focal plane are of substantially equal average and peak power.

14. The method of any of the preceding examples, wherein marks effected on the markable surface do not overlap.

15. The method of any of the preceding examples, wherein marks effected on the markable surface overlap.

16. The method of any of the preceding examples, wherein material forming the markable surface comprises a laser absorption additive.

17. The method of example 16, wherein the laser absorption additive is selected from the group consisting of titanium dioxide (TiO₂), antimony tin oxide (ATO), mica, Sb₂O₃, indium tin oxide, tin oxides, iron oxides, zinc oxide, carbon black, graphitic carbon, bismuth oxide, mixed metal oxides, metal nitrides, doped metal nitrides, metal carbides, metal borides, tungsten oxides, doped tungsten oxides, metal phosphates, pearlescent pigments, zero valent metals such as aluminum, and mixtures thereof, and preferably, titanium dioxide (TiO₂).

18. The method of any of the preceding examples, wherein the pulsed laser has an average power of at least 100 W, to 2000 W.

19. The method of any of the preceding examples wherein the pulsed laser is a nano-second pulsed laser, preferably a pico-second pulsed laser, and more preferably a femto-second pulsed laser.

20. The method of any of the preceding examples, wherein the pulsed laser is capable of a repetition rate of at least 100 kHz, preferably at least 200 kHz, more preferably at least 500 kHz, and even more preferably at least 1000 kHz, or even 3,000 kHz.

21. The method of any of the preceding examples, wherein the laser beam pulses have a pulse energy of from about 10 μJ to about 1000 μJ, preferably from about 20 μJ to about 800 μJ, more preferably from about 30 μJ to about 600 μJ, and even more preferably from about 40 μJ to about 500 μJ.

22. The method of any of the preceding examples, wherein the laser beam pulses have a wavelength of from about 200 nm to about 1100 nm.

23. The method of any of the preceding examples, wherein the laser beam pulses have a pulse duration less than about 20 picoseconds.

24. The method of any of the preceding examples wherein the markable surface has contours or curvature.

25. The method of example 24 wherein the markable surface is positioned for the marking process such that, when an area of the print assignment is substantially centered about an optical axis of the focusing lens, locations of a print surface area are on either side of the focal plane.

26. The method of either of examples 24 or 25 wherein one or both of row spacing and column spacing varies with the contours or curvature.

27. The method of any of the preceding examples, wherein the focusing lens has a focal length equal to or greater than 330 mm, preferably 1,000 mm and more preferably 2,000 mm, up to 4,000 mm.

28. The method of example 27, further including providing a beam expander disposed along a path of the laser beam pulses, between the pulsed laser and the beam guidance system.

29. The method of any of the preceding examples, wherein the print assignment includes alphanumeric characters, and the method further comprises the steps of:
identifying a dominant geometric vector direction of the alphanumeric characters in the print assignment;
arranging the grid to encompass the print assignment, wherein the orientation of one of either the rows or the columns of the grid aligns with the dominant geometric vector direction; and
determining the maximum allowable mark repeat distance along the dominant geometric vector direction to provide a predetermined level of legibility and/or quality of appearance in the print assignment, and adjusting spacing of the other of the either the rows or the columns of the grid, to correspond with the maximum allowable mark repeat distance along the dominant geometric vector direction.

30. The method of any of the preceding examples wherein the predetermined print assignment is divided into two or more subparts and a separate pulsed layer system is used to effect each of the subparts.

31. The method of any of the preceding examples wherein the pulsed laser system is controlled by a computing device that sends packets of instructions to the pulsed laser system, the packet of instructions comprising at least 2, preferably at least 4, more preferably at least 8, and even more preferably at least 16 or more individual instructions.

### B. Packeting

1. A method for marking an article with a pulsed laser to effect imprinting via the marking, while the article is in motion, the method comprising the steps of:
providing a pulsed laser system comprising a pulsed laser (configured to produce laser beam pulses, a beam gating system, a beam guidance system, and a focusing lens, the focusing lens having a focal plane and a field of view;
providing an article comprising a markable surface, and a conveyor that effects motion of the article;
configuring the conveyor such that at least a portion of the markable surface is positioned proximate the focal plane as the article travels within the field of view;
providing a predetermined print assignment to be processed on the markable surface;
conveying the article and the markable surface within the field of view; and
directing and guiding a target focus point for laser beam pulses to sweep along the focal plane such that the pulses impinge upon the markable surface and effect marks on the article at a plurality of locations corresponding with discrete locations of a grid in the focal plane;
wherein the grid has an outline circumscribing the print assignment and is constituted by a plurality of columns and rows of the discrete locations within the outline, wherein at each discrete location a laser beam pulse is directed, or withheld;
wherein the pulsed laser system is controlled by a computing device that sends packets of instructions to the pulsed laser system, the packet of instructions comprising at least 2, preferably at least 4, more preferably at least 8, and even more preferably at least 16 or more individual instructions; and
wherein the sweep occurs along a sweep direction at a constant velocity over mark locations, and wherein the constant velocity is greater than about 8 m/s, preferably greater than about 10 m/s, preferably greater than about 15 m/s, preferably greater than about 18 m/s, preferably greater than about 22 m/s, preferably greater than about 32 m/s, preferably greater than about 45 m/s, preferably greater than about 60 m/s, preferably greater than about 75 m/s, and preferably greater than about 90 m/s.

2. The method according to example 1, wherein at least 2 different packets are used to control beam pulses along one sweep.

3. The method of example 2, wherein 3 different packets are used to control beam pulses along one sweep.

4. The method of example 1, wherein the packets of instructions each contain two or fewer, preferably, only one individual instruction, relating to the position of a location in the grid pattern.

5. The method of any of the preceding examples wherein the focusing lens is a flat field lens or an f-theta lens, and preferably an f-theta lens.

6. The method of any of the preceding examples wherein the markable surface is positioned in the focal plane as the article moves within the field of view.

7. The method of any of the preceding examples wherein the guiding step causes the target focus point to sweep either successive rows, or successive columns, constituting the grid and all discrete locations thereof, wherein the sweep direction is selected as either along a direction of orientation of the rows or along a direction of orientation of the columns.

8. The method of any of the preceding examples wherein a number of turnarounds required for the laser beam to sweep over all of the discrete locations is minimized.

9. The method of any of the preceding examples wherein the average number of pulses emitted per sweep, that effect marks on the markable surface, is maximized.

10. The method of any of the preceding examples wherein the pulsed laser is held stationary.

11. The method of any of the preceding examples wherein the motion is translating motion.

12. The method of example 11 wherein the translating motion has a constant conveying speed.

13. The method of example 12 wherein the conveying speed is 0.1 m/s to 2.0 m/s, preferably 0.1 m/s to 5 m/s, and more preferably 0.1 m/s to 20 m/s.

14. The method of any of the preceding examples wherein grid outline has a surface area of 400 mm² to 20,000 mm².

15. The method of any of the preceding examples wherein the field of view has an area in the focal plane equal to or greater than 40,000 mm² to 2,250,000 mm².

16. The method of any of the preceding examples, wherein the laser beam pulses directed at the focal plane are of substantially equal average and peak power.

17. The method of any of the preceding examples, wherein marks effected on the markable surface do not overlap.

18. The method of any of the preceding examples, wherein marks effected on the markable surface overlap.

19. The method of any of the preceding examples, wherein material forming the markable surface comprises a laser absorption additive.

20. The method of example 19, wherein the laser absorption additive is selected from the group consisting of titanium dioxide (TiO₂), antimony tin oxide (ATO), mica, Sb₂O₃, indium tin oxide, tin oxides, iron oxides, zinc oxide, carbon black, graphitic carbon, bismuth oxide, mixed metal oxides, metal nitrides, doped metal nitrides, metal carbides, metal borides, tungsten oxides, doped tungsten oxides, metal phosphates, pearlescent pigments, zero valent metals such as aluminum, and mixtures thereof, and preferably, titanium dioxide (TiO₂).

21. The method of any of the preceding examples, wherein the pulsed laser has an average power of at least 100 W, to 2000 W.

22. The method of any of the preceding examples wherein the pulsed laser is a nano-second pulsed laser, preferably a pico-second pulsed laser, and more preferably a femto-second pulsed laser.

23. The method of any of the preceding examples, wherein the pulsed laser is capable of a repetition rate of at least 100 kHz, preferably at least 200 kHz, more preferably at least 500 kHz, and even more preferably at least 1000 kHz, or even 3,000 kHz.

24. The method of any of the preceding examples, wherein the laser beam pulses have a pulse energy of from about 10 μJ to about 1000 μJ, preferably from about 20 μJ to about 800 μJ, more preferably from about 30 μJ to about 600 μJ, and even more preferably from about 40 μJ to about 500 μJ.

25. The method of any of the preceding examples, wherein the laser beam pulses have a wavelength of from about 200 nm to about 1100 nm.

26. The method of any of the preceding examples, wherein the laser beam pulses have a pulse duration less than about 20 picoseconds.

27. The method of any of the preceding examples wherein the markable surface has contours or curvature.

28. The method of example 27 wherein the markable surface is positioned for the marking process such that, when an area of the print assignment is substantially centered about an optical axis of the focusing lens, locations of a print surface area are on either side of the focal plane.

29. The method of either of examples 27 or 28 wherein one or both of row spacing and column spacing varies with the contours or curvature.

30. The method of any of the preceding examples, wherein the focusing lens has a focal length equal to or greater than 330 mm, preferably 1,000 mm and more preferably 2,000 mm, up to 4,000 mm.

31. The method of example 30, further including providing a beam expander disposed along a path of the laser beam pulses, between the pulsed laser and the beam guidance system.

32. The method of any of the preceding examples, wherein the print assignment includes alphanumeric characters, and the method further comprises the steps of:
identifying a dominant geometric vector direction of the alphanumeric characters in the print assignment;
arranging the grid to encompass the print assignment, wherein the orientation of one of either the rows or the columns of the grid aligns with the dominant geometric vector direction; and
determining the maximum allowable mark repeat distance along the dominant geometric vector direction to provide a predetermined level of legibility and/or quality of appearance in the print assignment, and adjusting spacing of the other of the either the rows or the columns of the grid, to correspond with the maximum allowable mark repeat distance along the dominant geometric vector direction.

33. The method of any of the preceding examples wherein the rows have a first spacing and the columns have a second spacing, and the first and second spacings differ.

34. The method of any of the preceding examples wherein the predetermined print assignment is divided into two or more subparts and a separate pulsed layer system is used to effect each of the subparts.

### C. Marked Article

1. An article of manufacture having a surface that is imprinted without ink, the imprinting having been effected via impartation of a pattern of substantially circular marks created by one or more of oxidation, reduction, ablation, etching, foaming, carbonization or annealing of material at and/or proximate the surface of the article, wherein the marks are arranged in a grid pattern of rows and columns, wherein the rows have row spacing and the columns have column spacing, wherein the row spacing differs from the column spacing.

2. The article of example 1 wherein the surface is substantially planar.

3. The article of example 1 wherein the surface has curves or contours, and there is a variation in sizes of the substantially circular marks in subregions of the imprinted surface.

4. The article of either of the preceding examples wherein material comprising a thermoplastic polymer material forms the surface.

5. The article of example 4 wherein the thermoplastic polymer material comprises material selected from the group consisting of polyethylene terephthalate, polyethylene terephthalate glycol, polystyrene, polycarbonate, polyvinylchloride, polyethylene naphthalate, polycyclohexylenedimethylene terephthalate, glycol-modified PCT copolymer, copolyester of cyclohexanedimethanol and terephthalic acid, polybutylene terephthalate, acrylonitrile styrene, styrene butadiene copolymer, or a polyolefin, for example one of low-density polyethylene, linear low-density polyethylene, high-density polyethylene, propylene, and any combinations thereof.

6. The article of example 5 wherein the thermoplastic polymer material includes an additive selected from the group consisting of titanium dioxide, antimony tin oxide (ATO), ATO-coated substrates such as mica, Sb₂O₃, indium tin oxide, tin oxides, iron oxides, zinc oxide, carbon black, graphitic carbon, bismuth oxide, mixed metal oxides, metal nitrides, doped metal nitrides, metal carbides, metal borides, tungsten oxides, doped tungsten oxides, metal phosphates, pearlescent pigments, zero valent metals, and mixtures thereof.

7. The article of any of the preceding examples wherein the imprinted surface comprises imprinting of alphanumeric characters.

8. The article of example 7 wherein the alphanumeric characters have a dominant geometric vector direction.

9. The article of example 8 wherein either the rows, or the columns, are oriented along the dominant geometric vector direction.

10. The article of example 9 wherein spacing of the either the rows or the columns oriented along the dominant geometric vector direction is less than spacing of the other of the rows or the columns not oriented along the dominant geometric vector direction.

11. The article of any of the preceding examples wherein either one of the row or column spacings is 0.005 mm to 0.1 mm.

12. The article of example 11 wherein the other of the row or column spacings is 0.025 mm to 1 mm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments contemplated herein have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article of manufacture having a surface that is imprinted without ink, the imprinting having been effected via impartation of a pattern of substantially circular marks created by one or more of oxidation, reduction, ablation, etching, foaming, carbonization or annealing of material at and/or proximate the surface of the article, wherein the marks are arranged in a grid pattern of rows and columns, wherein the rows have row spacing and the columns have column spacing, wherein the row spacing differs from the column spacing.

2. The article of claim 1 wherein the surface is substantially planar.

3. The article of claim 1 wherein the surface has curves or contours, and there is a variation in sizes of the substantially circular marks in subregions of the imprinted surface.

4. The article of claim 1 wherein material comprising a thermoplastic polymer material forms the surface.

5. The article of claim 4 wherein the thermoplastic polymer material comprises material selected from the group consisting of polyethylene terephthalate, polyethylene terephthalate glycol, polystyrene, polycarbonate, polyvinylchloride, polyethylene naphthalate, polycyclohexylenedimethylene terephthalate, glycol-modified PCT copolymer, copolyester of cyclohexanedimethanol and terephthalic acid, polybutylene terephthalate, acrylonitrile styrene, styrene butadiene copolymer, or a polyolefin, for example one of low-density polyethylene, linear low-density polyethylene, high-density polyethylene, propylene, and any combinations thereof.

6. The article of claim 5 wherein the thermoplastic polymer material includes an additive selected from the group consisting of titanium dioxide, antimony tin oxide (ATO), ATO-coated substrates such as mica, Sb₂O₃, indium tin oxide, tin oxides, iron oxides, zinc oxide, carbon black, graphitic carbon, bismuth oxide, mixed metal oxides, metal nitrides, doped metal nitrides, metal carbides, metal borides, tungsten oxides, doped tungsten oxides, metal phosphates, pearlescent pigments, zero valent metals, and mixtures thereof.

7. The article of claim 1 wherein the imprinted surface comprises imprinting of alphanumeric characters.

8. The article of claim 7 wherein the alphanumeric characters have a dominant geometric vector direction.

9. The article of claim 8 wherein either the rows, or the columns, are oriented along the dominant geometric vector direction.

10. The article of claim 9 wherein spacing of the either the rows or the columns oriented along the dominant geometric vector direction is less than spacing of the other of the rows or the columns not oriented along the dominant geometric vector direction.

11. The article of claim 1 wherein either one of the row or column spacings is 0.005 mm to 0.1 mm.

12. The article of claim 11 wherein the other of the row or column spacings is 0.025 mm to 1 mm.
